(19) United States
(12) Patent Application Publication
(10) Pub. No.: US 2023/0254850 A1
(43) Pub. Date: Aug. 10, 2023

(54) METHOD AND APPARATUS FOR SCHEDULING DATA CHANNEL

(71) Applicant: ELECTRONICS AND TELECOMMUNICATIONS RESEARCH INSTITUTE, Daejeon (KR)

(72) Inventors: Sung Hyun MOON, Daejeon (KR); Cheul Soon KIM, Daejeon (KR); Jung Hoon LEE, Daejeon (KR)

(73) Assignees: ELECTRONICS AND TELECOMMUNICATIONS RESEARCH INSTITUTE, Daejeon (KR); ELECTRONICS AND TELECOMMUNICATIONS RESEARCH INSTITUTE, Daejeon (KR)

(21) Appl. No.: 18/097,063

(22) Filed: Jan. 13, 2023

(30) Foreign Application Priority Data
Jan. 14, 2022 (KR) 10-2022-0006199
Feb. 4, 2022 (KR) 10-2022-0015107
Jan. 13, 2023 (KR) 10-2023-0005420

(51) Int. Cl. H04W 72/1268; H04W 72/232; H04W 72/02

(52) U.S. Cl. CPC H04W 72/1268; H04W 72/232; H04W 72/02

(57) ABSTRACT

Disclosed are a method and an apparatus for data channel scheduling. A method of a terminal may comprise: receiving, from a base station, CG configuration information including a plurality of CG occasions; receiving, from the base station, first DCI; activating a first CG occasion and a second CG occasion among the plurality of CG occasions based on indication information included in the first DCI; and selecting at least one CG occasion(s) from among the activated first CG occasion and second CG occasion; and transmitting a PUSCH to the base station based on the selected CG occasion(s), wherein the first CG occasion includes N1 PUSCH resource(s), the second CG occasion includes N2 PUSCH resource(s), and N1 and N2 are natural numbers.

### CROSS-REFERENCE TO RELATED APPLICATIONS

This application claims priority to Korean Patent Applications No. 10-2022-0006199, filed on Jan. 14, 2022, No. 10-2022-0015107, filed on Feb. 4, 2022, and No. 10-2023-0005420, filed on Jan. 13, 2023, with the Korean Intellectual Property Office (KIPO), the entire contents of which are hereby incorporated by reference.

### BACKGROUND

### 1. Technical Field

The present disclosure relate to a technique for transmitting and receiving a data channel in a communication system, and more particularly, to scheduling technique for pseudo periodic traffic transmission.

### 2. Related Art

A mobile communication system may be a core infrastructure driving the overall development of the Internet and communication technology (ICT) industry, and is evolving step by step overcoming the disadvantages and limitations of the existing communication networks. A next-generation wireless communication system can provide various advanced services in usage scenarios such as enhanced mobile broadband (eMBB), ultra-reliable low-latency communication (URLC), and massive machine type communication (mMTC). In order to provide a variety of advanced services, a used frequency band tends to gradually expand. For example, the conventional wireless communication system (e.g., long term evolution (LTE) communication system) may utilize a frequency band of 6 to 7 GHz or less, and the next-generation wireless communication system (e.g., new radio (NR) communication system or 6G communication system) may utilize up to a frequency band of tens to hundreds of GHz. In the above-described communication system, it is necessary to develop an efficient resource management technique considering various traffic characteristics and terminal types and a low-power operation technique for terminals, and the like.

### SUMMARY

The present disclosure is directed to providing a method and an apparatus for scheduling a data channel for pseudo periodic traffic transmission.

According to a first exemplary embodiment of the present disclosure, A method of a terminal may comprise: receiving, from a base station, configured grant (CG) configuration information including a plurality of CG occasions; receiving, from the base station, first downlink control information (DCI); activating a first CG occasion and a second CG occasion among the plurality of CG occasions based on indication information included in the first DCI; selecting at least one CG occasion(s) from among the activated first CG occasion and second CG occasion; and transmitting a physical uplink shared channel (PUSCH) to the base station based on the selected CG occasion(s), wherein the first CG occasion includes N1 PUSCH resource(s), the second CG occasion includes N2 PUSCH resource(s), and N1 and N2 are natural numbers.

The first DCI may further include resource allocation information of the N1 PUSCH resource(s) and the N2 PUSCH resource(s).

The CG configuration information may include information on a PUSCH resource set including candidate PUSCH resource(s), and the N1 PUSCH resource(s) and the N2 PUSCH resource(s) may be determined based on the PUSCH resource set.

The N1 PUSCH resource(s) and the N2 PUSCH resource(s) may repeatedly appear according to a common periodicity.

A duration of the N1 PUSCH resource(s) and a duration of the N2 PUSCH resource(s) may be the same.

A time when the first CG occasion is activated and a time when the second CG occasion is activated may be the same.

Information on the selected CG occasion(s) may be included in uplink control information (UCI), and the UCI may be transmitted by the terminal to the base station.

Information on one or more CG occasion(s) other than the selected CG occasion(s) among the plurality of CG occasions may be included in UCI, and the UCI may be transmitted by the terminal to the base station.

The PUSCH may not be transmitted in PUSCH resource(s) included in the one or more CG occasion(s).

The method may further comprise: receiving, from the base station, second DCI including release indication information; and releasing at least the N1 PUSCH resource(s) based on the release indication information, wherein the release indication information includes an index of the first CG occasion.

According to a second exemplary embodiment of the present disclosure, a method of a base station may comprise: transmitting, to a terminal, configured grant (CG) configuration information including a plurality of CG occasions; transmitting first downlink control information (DCI) to the terminal; and receiving, from the terminal, a physical uplink shared channel (PUSCH) in at least one CG occasion(s) of a first CG occasion and a second CG occasion activated based on indication information included in the first DCI among the plurality of CG occasions, wherein the first CG occasion includes N1 PUSCH resource(s), the second CG occasion includes N2 PUSCH resource(s), and N1 and N2 are natural numbers.

The first DCI may further include resource allocation information of the N1 PUSCH resource(s) and the N2 PUSCH resource(s).

The CG configuration information may include information on a PUSCH resource set including candidate PUSCH resource(s), and the N1 PUSCH resource(s) and the N2 PUSCH resource(s) may be determined based on the PUSCH resource set.

The N1 PUSCH resource(s) and the N2 PUSCH resource(s) may repeatedly appear according to a common periodicity.

A duration of the N1 PUSCH resource(s) and a duration of the N2 PUSCH resource(s) may be the same.

A time when the first CG occasion is activated and a time when the second CG occasion is activated may be the same.

The method may further comprise: receiving, from the terminal, uplink control information (UCI) including information on the at least one CG occasion(s) in which the PUSCH is received.

The method may further comprise: receiving, from the terminal, UCI including information on one or more CG occasion(s) excluding the at least one CG occasion(s) in which the PUSCH is received among the plurality of CG occasions.

The PUSCH may not be transmitted in PUSCH resource(s) included in the one or more CG occasion(s).

The method may further comprise: transmitting, to the base station, second DCI including release indication information, wherein at least the N1 PUSCH resource(s) may be released based on the release indication information, and the release indication information may include an index of the first CG occasion.

According to the present disclosure, a plurality of configured grant (CG) occasions may be configured in a terminal, and the terminal may activate two or more CG occasions among the plurality of CG occasions. The activation of the two or more CG occasions may be indicated by downlink control information (DCI) received from a base station. The terminal may perform physical uplink shared channel (PUSCH) transmission to the base station based on at least one CG occasion among two or more activated CG occasions. Accordingly, uplink transmissions can be efficiently performed, and performance of the communication system can be improved.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of an apparatus.

FIG. 3 is a conceptual diagram illustrating a first exemplary embodiment of a DRX operation method of a terminal.

FIG. 4 is a conceptual diagram illustrating a first exemplary embodiment of a periodic traffic transmission method based on a plurality of DRX configurations.

FIG. 5 is a conceptual diagram illustrating a first exemplary embodiment of a periodic traffic transmission method based on SPS PDSCH configuration.

FIG. 6 is a conceptual diagram illustrating a first exemplary embodiment of a method for configuring uplink resources for SPS HARQ-ACK transmission.

FIG. 7 is a conceptual diagram illustrating a second exemplary embodiment of a method for configuring uplink resources for SPS HARQ-ACK transmission.

In FIG. 8, a case (a) corresponds to a first exemplary embodiment of an SPS PDSCH retransmission method, and a case (b) corresponds to a second exemplary embodiment of an SPS PDSCH retransmission method.

FIG. 9A is a conceptual diagram illustrating a first exemplary embodiment of a PDCCH monitoring resource configuration method for retransmission of an SPS PDSCH, and FIG. 9B is a conceptual diagram illustrating a second exemplary embodiment of a PDCCH monitoring resource configuration method for retransmission of an SPS PDSCH.

FIG. 10 is a conceptual diagram illustrating a first exemplary embodiment of an SPS configuration method based on a plurality of periodicities.

FIG. 11 is a conceptual diagram illustrating a second exemplary embodiment of an SPS configuration method based on a plurality of periodicities.

FIG. 12 is a conceptual diagram illustrating a first exemplary embodiment of a method for dynamically indicating an SPS occasion.

FIG. 13 is a conceptual diagram illustrating a second exemplary embodiment of a method for dynamically indicating an SPS occasion.

FIG. 14 is a conceptual diagram illustrating a third exemplary embodiment of a method for dynamically indicating an SPS occasion.

FIG. 15 is a conceptual diagram illustrating a first exemplary embodiment of an SPS resource configuration method for a plurality of SPS configurations.

FIG. 16 is a conceptual diagram illustrating a first exemplary embodiment of a method of individually activating a plurality of CG occasions.

FIG. 17 is a conceptual diagram illustrating a first exemplary embodiment of a method of simultaneously activating a plurality of CG occasions.

FIG. 18 is a conceptual diagram illustrating a second exemplary embodiment of a method of simultaneously activating a plurality of CG occasions.

### DETAILED DESCRIPTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, ‘configuration of an operation (e.g., transmission operation)’ may mean ‘signaling of configuration information (e.g., information element(s), parameter(s)) for the operation’ and/or ‘signaling of information indicating performing of the operation’. ‘Configuration of information element(s) (e.g., parameter(s))’ may mean that the corresponding information element(s) are signaled. ‘Configuration of a resource (e.g., resource region)’ may mean that configuration information of the corresponding resource is signaled. The signaling may be performed based on at least one of system information (SI) signaling (e.g., transmission of system information block (SIB) and/or master information block (MIB)), RRC signaling (e.g., transmission of RRC parameters and/or higher layer parameters), MAC control element (CE) signaling, PHY signaling (e.g., transmission of downlink control information (DCI), uplink control information (UCI), and/or sidelink control information (SCI)), or a combination thereof.

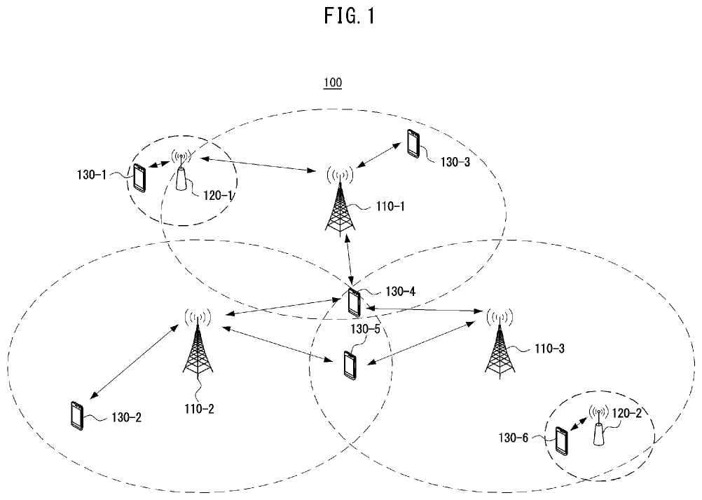

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g., a serving gateway (S-GW), a packet data network (PDN) gateway (P-GW), and a mobility management entity (MME)). When the communication system 100 is a 5G communication system (e.g., New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g., LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows.

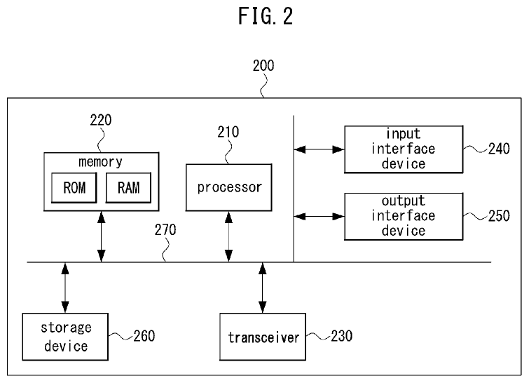

FIG. 2 is a block diagram illustrating a first exemplary embodiment of an apparatus.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

The present disclosure may relate to techniques for transmitting and receiving signals in a communication system. Methods of transmitting a downlink control channel for reducing power consumption of a terminal in a wireless communication system will be described. The exemplary embodiments of the present disclosure may be applied not only to the NR communication system but also to other communication systems (e.g., LTE communication system, 5G communication system, 6G communication system, or the like).

The NR communication system may support a system bandwidth (e.g., carrier bandwidth) wider than a system bandwidth provided by the LTE communication system in order to efficiently use a wide frequency band. For example, the maximum system bandwidth supported by the LTE communication system may be 20 MHz. On the other hand, the NR communication system may support a carrier bandwidth of up to 100 MHz in a frequency band of 6 GHz or below, and may support a carrier bandwidth of up to 400 MHz in a frequency band of 6 GHz or above.

A numerology applied to physical signals and channels in the communication system (e.g., NR communication system or 6G communication system) may be variable. The numerology may vary to satisfy various technical requirements of the communication system. In the communication system to which a cyclic prefix (CP) based OFDM waveform technology is applied, the numerology may include a subcarrier spacing and a CP length (or CP type). Table 1 below may be a first exemplary embodiment of configuration of numerologies for the CP-based OFDM. The subcarrier spacings may have an exponential multiplication relationship of 2, and the CP length may be scaled at the same ratio as the OFDM symbol length. Depending on a frequency band in which the communication system operates, at least some numerologies among the numerologies of Table 1 may be supported. In addition, in the communication system, numerologies not listed in Table 1 may be further supported. CP type(s) not listed in Table 1 (e.g., extended CP) may be additionally supported for a specific subcarrier spacing (e.g., 60 kHz).

TABLE 1

| Subcarrier | 15 | 30 | 60 | 120 | 240 | 480 |
|---|---|---|---|---|---|---|
| spacing | kHz | kHz | kHz | kHz | kHz | kHz |
| OFDM symbol | 66.7 | 33.3 | 16.7 | 8.3 | 4.2 | 2.1 |
| length [μs] | | | | | | |
| CP length | 4.76 | 2.38 | 1.19 | 0.60 | 0.30 | 0.15 |
| [μs] | | | | | | |
| Number of | 14 | 28 | 56 | 112 | 224 | 448 |
| OFDM symbols | | | | | | |
| within 1 ms | | | | | | |

In the following description, a frame structure in the communication system will be described. In the time domain, elements constituting a frame structure may include a subframe, slot, mini-slot, symbol, and the like. The subframe may be used as a unit for transmission, measurement, and the like, and the length of the subframe may have a fixed value (e.g., 1 ms) regardless of a subcarrier spacing. A slot may comprise consecutive symbols (e.g., 14 OFDM symbols). The length of the slot may be variable differently from the length of the subframe. For example, the length of the slot may be inversely proportional to the subcarrier spacing.

A slot may be used as a unit for transmission, measurement, scheduling, resource configuration, timing (e.g., scheduling timing, hybrid automatic repeat request (HARQ) timing, channel state information (CSI) measurement and reporting timing, etc.), and the like. The length of an actual time resource used for transmission, measurement, scheduling, resource configuration, etc. may not match the length of a slot. A mini-slot may include consecutive symbol(s), and the length of a mini-slot may be shorter than the length of a slot. A mini-slot may be used as a unit for transmission, measurement, scheduling, resource configuration, timing, and the like. A mini-slot (e.g., the length of a mini-slot, a mini-slot boundary, etc.) may be predefined in the technical specification. Alternatively, a mini-slot (e.g., the length of a mini-slot, a mini-slot boundary, etc.) may be configured (or indicated) to the terminal. When a specific condition is satisfied, use of a mini-slot may be configured (or indicated) to the terminal.

The base station may schedule a data channel (e.g., physical downlink shared channel (PDSCH), physical uplink shared channel (PUSCH), physical sidelink shared channel (PSSCH)) using some or all of symbols constituting a slot. In particular, for URLLC transmission, unlicensed band transmission, transmission in a situation where an NR communication system and an LTE communication system coexist, and multi-user scheduling based on analog beamforming, a data channel may be transmitted using a portion of a slot. In addition, the base station may schedule a data channel using a plurality of slots. In addition, the base station may schedule a data channel using at least one mini-slot.

In the frequency domain, elements constituting the frame structure may include a resource block (RB), subcarrier, and the like. One RB may include consecutive subcarriers (e.g., 12 subcarriers). The number of subcarriers constituting one RB may be constant regardless of a numerology. In this case, a bandwidth occupied by one RB may be proportional to a subcarrier spacing of a numerology. An RB may be used as a transmission and resource allocation unit for a data channel, control channel, and the like. Resource allocation of a data channel may be performed in units of RBs or RB groups (e.g., resource block group (RBG)). One RBG may include one or more consecutive RBs. Resource allocation of a control channel may be performed in units of control channel elements (CCEs). One CCE in the frequency domain may include one or more RBs.

In the NR communication system, a slot (e.g., slot format) may be composed of a combination of one or more of downlink period, flexible period (or unknown period), and an uplink period. Each of a downlink period, flexible period, and uplink period may be comprised of one or more consecutive symbols. A flexible period may be located between a downlink period and an uplink period, between a first downlink period and a second downlink period, or between a first uplink period and a second uplink period. When a flexible period is inserted between a downlink period and an uplink period, the flexible period may be used as a guard period.

A slot may include one or more flexible periods. Alternatively, a slot may not include a flexible period. The terminal may perform a predefined operation in a flexible period. Alternatively, the terminal may perform an operation configured by the base station semi-statically or periodically. For example, the periodic operation configured by the base station may include a PDCCH monitoring operation, synchronization signal/physical broadcast channel (SS/PBCH) block reception and measurement operation, channel state information-reference signal (CSI-RS) reception and measurement operation, downlink semi-persistent scheduling (SPS) PDSCH reception operation, sounding reference signal (SRS) transmission operation, physical random access channel (PRACH) transmission operation, periodically-configured PUCCH transmission operation, PUSCH transmission operation according to a configured grant, and the like. A flexible symbol may be overridden by a downlink symbol or an uplink symbol. When a flexible symbol is overridden by a downlink or uplink symbol, the terminal may perform a new operation instead of the existing operation in the corresponding flexible symbol (e.g., overridden flexible symbol).

A slot format may be configured semi-statically by higher layer signaling (e.g., radio resource control (RRC) signaling). Information indicating a semi-static slot format may be included in system information, and the semi-static slot format may be configured in a cell-specific manner. In addition, a semi-static slot format may be additionally configured for each terminal through terminal-specific higher layer signaling (e.g., RRC signaling). A flexible symbol of a slot format configured cell-specifically may be overridden by a downlink symbol or an uplink symbol by terminal-specific higher layer signaling. In addition, a slot format may be dynamically indicated by physical layer signaling (e.g., slot format indicator (SFI) included in downlink control information (DCI)). The semi-statically configured slot format may be overridden by a dynamically indicated slot format. For example, a semi-static flexible symbol may be overridden by a downlink symbol or an uplink symbol by SFI.

The terminal may perform downlink operations, uplink operations, and sidelink operations in a bandwidth part. A bandwidth part may be defined as a set of consecutive RBs (e.g., physical resource blocks (PRBs)) having a specific numerology in the frequency domain. One numerology may be used for transmission of signals (e.g., transmission of control channel or data channel) in one bandwidth part. In exemplary embodiments, when used in a broad sense, a ‘signal’ may refer to any physical signal and channel. A terminal performing an initial access procedure may obtain configuration information of an initial bandwidth part from the base station through system information. A terminal operating in an RRC connected state may obtain the configuration information of the bandwidth part from the base station through terminal-specific higher layer signaling.

The configuration information of the bandwidth part may include a numerology (e.g., a subcarrier spacing and a CP length) applied to the bandwidth part. Also, the configuration information of the bandwidth part may further include information indicating a position of a start RB (e.g., start PRB) of the bandwidth part and information indicating the number of RBs (e.g., PRBs) constituting the bandwidth part. At least one bandwidth part among the bandwidth part(s) configured in the terminal may be activated. For example, within one carrier, one uplink bandwidth part and one downlink bandwidth part may be activated respectively. In a time division duplex (TDD) based communication system, a pair of an uplink bandwidth part and a downlink bandwidth part may be activated. The base station may configure a plurality of bandwidth parts to the terminal within one carrier, and may switch the active bandwidth part of the terminal.

In exemplary embodiments, the expression ‘a certain frequency band (e.g., carrier, bandwidth part, RB set, listen before talk (LBT) subband, guard band, or the like) is activated’ may mean that the base station or terminal is in a state of capable of transmitting and receiving a signal by using the frequency band. In addition, the expression ‘a certain frequency band is activated’ may mean that a radio frequency (RF) filter (e.g., band pass filter) of a transceiver is in a state of operating in a frequency band including the certain frequency band.

In exemplary embodiments, an RB may mean a common RB (CRB). Alternatively, an RB may mean a PRB or a virtual RB (VRB). In the NR communication system, a CRB may refer to an RB constituting a set of consecutive RBs (e.g., common RB grid) based on a reference frequency (e.g., point A). Carriers, bandwidth part, and the like may be arranged on the common RB grid. In other words, a carrier, bandwidth part, etc. may be composed of CRB(s). An RB or CRB constituting a bandwidth part may be referred to as a PRB, and a CRB index within the bandwidth part may be appropriately converted into a PRB index. In an exemplary embodiment, an RB may refer to an interlace RB (IRB).

A PDCCH may be used to transmit DCI or a DCI format to the terminal. A minimum resource unit constituting a PDCCH may be a resource element group (REG). An REG may be composed of one PRB (e.g., 12 subcarriers) in the frequency domain and one OFDM symbol in the time domain. Thus, one REG may include 12 resource elements (REs). A demodulation reference signal (DMRS) for demodulating a PDCCH may be mapped to 3 REs among 12 REs constituting the REG, and control information (e.g., modulated DCI) may be mapped to the remaining 9 REs.

One PDCCH candidate may be composed of one CCE or aggregated CCEs. One CCE may be composed of a plurality of REGs. The NR communication system may support CCE aggregation levels 1, 2, 4, 8, 16, and the like, and one CCE may consist of six REGs.

A control resource set (CORESET) may be a resource region in which the terminal performs a blind decoding on PDCCHs. The CORESET may be composed of a plurality of REGs. The CORESET may consist of one or more PRBs in the frequency domain and one or more symbols (e.g., OFDM symbols) in the time domain. The symbols constituting one CORESET may be consecutive in the time domain. The PRBs constituting one CORESET may be consecutive or non-consecutive in the frequency domain. One DCI (e.g., one DCI format or one PDCCH) may be transmitted within one CORESET. A plurality of CORESETs may be configured with respect to a cell and a terminal, and the plurality of CORESETs may overlap in time-frequency resources.

A CORESET may be configured in the terminal by a PBCH (e.g., system information or a master information block (MIB) transmitted on the PBCH). The identifier (ID) of the CORESET configured by the PBCH may be 0. That is, the CORESET configured by the PBCH may be referred to as a CORESET #0. A terminal operating in an RRC idle state may perform a monitoring operation in the CORESET #0 in order to receive a first PDCCH in the initial access procedure. Not only terminals operating in the RRC idle state but also terminals operating in the RRC connected state may perform monitoring operations in the CORESET #0. The CORESET may be configured in the terminal by other system information (e.g., system information block type 1 (SIB 1)) other than the system information transmitted through the PBCH. For example, for reception of a random access response (or Msg2) in a random access procedure, the terminal may receive the SIB 1 including the configuration information of the CORESET. Also, the CORESET may be configured in the terminal by terminal-specific higher layer signaling (e.g., RRC signaling).

In each downlink bandwidth part, one or more CORESETs may be configured for the terminal. Here, the expression ‘a CORESET is configured in a bandwidth part’ may mean that the CORESET is logically associated with the bandwidth part, and the terminal monitors the CORESET in the bandwidth part. The initial downlink active bandwidth part may include the CORESET #0 and may be associated with the CORESET #0. The CORESET #0 having a quasi-co-location (QCL) relationship with a synchronization signal block (SSB) may be configured for the terminal in a primary cell (PCell), a secondary cell (SCell), and a primary secondary cell (PSCell). In the secondary cell (SCell), the CORESET #0 may not be configured for the terminal.

A search space may be a set of candidate resource regions through which PDCCHs can be transmitted. The terminal may perform a blind decoding on each of the PDCCH candidates within a predefined search space. The terminal may determine whether a PDCCH is transmitted to itself by performing a cyclic redundancy check (CRC) on a result of the blind decoding. When it is determined that a PDCCH is a PDCCH for the terminal itself, the terminal may receive the PDCCH.

A PDCCH candidate may be configured with CCEs selected by a predefined hash function within an occasion of the CORESET or the search space. The search space may be defined and configured for each CCE aggregation level. In this case, a set of search spaces for all CCE aggregation levels may be referred to as a ‘search space set’. In exemplary embodiments, ‘search space’ may mean ‘search space set’, and ‘search space set’ may mean ‘search space’.

A search space set may be logically associated with one CORESET. One CORESET may be logically associated with one or more search space sets. A common search space set configured through the PBCH may be used to monitor DCI scheduling a PDSCH for transmitting an SIB 1. An ID of the common search space set configured through the PBCH may be set to 0. That is, the common search space set configured through the PBCH may be defined as a Type 0 PDCCH common search space set or a search space set #0. The search space set #0 may be logically associated with the CORESET #0.

The search space set may be classified into a common search space set and a terminal (UE)-specific search space set according to the purpose of the search space set and/or operations related to the search space set. Common DCI may be transmitted in the common search space set, and terminal (UE)-specific DCI may be transmitted in the UE-specific search space set. Considering scheduling freedom and/or fallback transmission, UE-specific DCI may be transmitted even in the common search space set. For example, common DCI may include at least one of resource allocation information of a PDSCH for transmission of system information, paging, power control command, slot format indicator (SFI), or preemption indicator. UE-specific DCI may include resource allocation information of a PDSCH, resource allocation information of a PUSCH, and/or the like. A plurality of DCI formats may be defined according to a payload, size, type of a radio network temporary identifier (RNTI), and/or the like of the DCI.

In the present disclosure, a common search space may be referred to as ‘CSS’, and a common search space set may be referred to as ‘CSS set’. A UE-specific search space may be referred to as ‘USS’, and a UE-specific search space set may be referred to as ‘USS set’.

Meanwhile, when the terminal always monitors downlink control channels (e.g., PDCCH) regardless of traffic presence, unnecessary power consumption of the terminal may occur. Accordingly, the terminal may perform a discontinuous reception (DRX) operation.

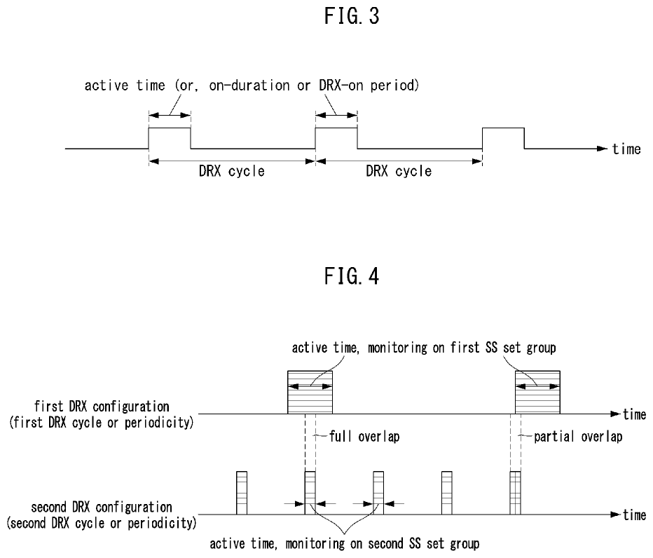

FIG. 3 is a conceptual diagram illustrating a first exemplary embodiment of a DRX operation method of a terminal.

Referring to FIG. 3, a base station may transmit configuration information of a DRX cycle to a terminal. The terminal may receive the configuration information of the DRX cycle from the base station, and may identify the DRX cycle configured by the base station. The terminal may perform a PDCCH monitoring operation in an active time for each DRX cycle, and may omit the PDCCH monitoring operation in the remaining time period. The active time may also be referred to as an on-duration, a DRX-on period, and the like, and a time period other than the active time may be referred to as a DRX-off period, a DRX period, and the like.

The active time (e.g., DRX active time) may include an operation time of an on-duration timer, an operation time of a DRX inactivity timer, and/or the like. The on-duration timer may start at a start time of each DRX cycle. Alternatively, the on-duration timer may start at a time later by a predetermined offset than the start time of each DRX cycle. That is, a start time of the active time may coincide with the start time of the DRX cycle or may be later than the start time of the DRX cycle by a predetermined time offset. The terminal may regard a period from the start of the on-duration timer to an expiration time of the on-duration timer as the active time. In addition, when the DRX inactivity timer is set, the terminal may monitor PDCCHs for a predetermined time period from a time (e.g., slot, subframe, symbol) when a PDCCH is successfully received. That is, the DRX inactivity timer may be started or reset at a time (e.g., slot, subframe, symbol) when the terminal successfully receives a PDCCH. The terminal may regard a period from the start or reset time of the DRX inactivity timer to an expiration time of the DRX inactivity timer as the active time. The above-described timers may decrease by 1 for each reference time unit (e.g., slot, subframe, or symbol group). The timer may expire at a time (e.g., slot, subframe, or symbol group) when a value of the timer becomes 0. The symbol group may include one or more symbols.

According to the above-described operations, when the terminal successfully receives a PDCCH in an active time of a certain DRX cycle, the DRX inactivity timer of the terminal may be started, and the active time may be extended by the start of the DRX inactivity timer. On the other hand, when a PDCCH is not received during an active time of a certain DRX cycle, the terminal may enter a DRX-off state again at an expiration time of the on-duration timer. For example, the terminal may regard a period in which at least one of the on-duration timer and the DRX inactivity timer operates as the active time. In addition, the terminal may receive a medium access control (MAC) control element (CE) from the base station, and the MAC CE may instruct the terminal to enter a DRX-off period. In this case, the terminal may transition its operation mode to a DRX-off mode regardless of a value of the operating timer, and in this case, the on-duration timer and the DRX inactivity timer may be stopped.

The DRX operation may be classified into a DRX operation according to a long DRX cycle (hereinafter referred to as ‘long DRX operation’) and a DRX operation according to a short DRX cycle (hereinafter referred to as ‘short DRX operation’). Only one of the long DRX operation and the short DRX operation may be performed. Alternatively, the long DRX operation and the short DRX operation may be performed in combination. The above-described operation may be performed for each DRX cycle. The above-described operation may be applied to a terminal in the RRC connected mode. Alternatively, the above-described operation may be applied to a terminal in the RRC idle mode or inactive mode.

Meanwhile, mobile data traffic may have unique characteristics and requirements according to an application service. For example, realistic service traffic such as extended reality (XR) may include real-time video information, and the video information may be periodically generated according to a scan rate. In addition, a high data rate may be required to support high-resolution videos in the XR service, and URLLC requirements may be satisfied to enable real-time interaction or immediate responses. In addition, since it may be difficult to mount a high-capacity battery in an XR terminal (e.g., a head mounted display (HMD)-type terminal, or the like), low-power operations of the terminal may be essentially supported.

The DRX operation may be effective in transmitting the above-described periodic traffic. The DRX cycle, active time (or on-duration), and the like of the terminal may be configured according to a periodic occurrence time of the traffic, and the terminal may perform a PDCCH monitoring operation or perform a downlink signal reception operation in an active time of each DRX cycle, and may periodically perform a transmission operation or a reception operation for traffic. The terminal may reduce unnecessary power consumption by not performing a PDCCH monitoring operation in the remaining period (e.g., period outside the active time).

FIG. 4 is a conceptual diagram illustrating a first exemplary embodiment of a periodic traffic transmission method based on a plurality of DRX configurations.

Referring to FIG. 4, the terminal may receive information on a plurality of DRX configurations from the base station, and perform a PDCCH monitoring operation based on the plurality of DRX configurations. The terminal may monitor a PDCCH in an active time (or on-duration) that appears periodically based on a first DRX cycle (or first DRX periodicity) according to a first DRX configuration, and may monitor a PDCCH in an active time (or on-duration) that appears periodically based on a second DRX cycle (or second DRX periodicity) according to a second DRX configuration. The first DRX cycle (or first DRX periodicity) and the second DRX cycle (or second DRX periodicity) may be independently configured to the terminal. The first DRX cycle (or first DRX periodicity) and the second DRX cycle (or second DRX periodicity) may have the same value or different values. For example, the first DRX configuration may be a configuration for a general low-power PDCCH monitoring operation of the terminal, and the first DRX cycle (or first DRX periodicity) according to the first DRX configuration may be set to a relatively long cycle. On the other hand, the second DRX configuration may be configured for periodic transmission of specific traffic (e.g., XR traffic), and the second DRX cycle (or the second DRX periodicity) according to the second DRX configuration may be set to correspond to an occurrence (or arrival) periodicity of the specific traffic (e.g., XR traffic). According to an exemplary embodiment, the second DRX cycle (or second DRX periodicity) may be shorter than the first DRX cycle (or first DRX periodicity). In the present disclosure, a period value may mean periodicity.

The terminal may monitor different search space sets (or different CORESETs corresponding to the different search space sets, or different PDCCH monitoring occasions corresponding to the different search space sets) for the plurality of DRX configurations. That is, the terminal may monitor a first search space set group in an active time according to the first DRX cycle, and monitor a second search space set group in an active time according to the second DRX cycle. For example, the second search space set group may be configured to include only minimum PDCCH candidate(s) for periodic transmission of the specific traffic (e.g., XR traffic). Specifically, the second search space set group may include one search space set (e.g., one USS set), and a monitoring periodicity of the search space set may be set equal to an XR traffic occurrence periodicity. On the other hand, the first search space set group may include not only a search space set for unicast transmission but also a search space set for transmission of DCI scheduling broadcast control information or common control information (e.g., Type 0/0A/1/2 CSS set, Type 3 CSS set). The search space set(s) (e.g., search space set groups) monitored by the terminal for each DRX configuration may be transmitted from the base station to the terminal through a signaling procedure (e.g., RRC signaling procedure).

According to the above-described exemplary embodiment, the terminal may periodically perform a PDCCH monitoring operation by the DRX operation (e.g., operation based on the second DRX configuration), and the base station may periodically perform dynamic scheduling of PDSCH or PUSCH including XR traffic at a PDCCH monitoring time for the terminal. The terminal may not perform a PDCCH monitoring operation outside the active time, and accordingly, power consumption of the terminal may be reduced. However, according to the above-described method, a PDCCH (or DCI) including scheduling information may need to be transmitted to the terminal in every period, which may increase signaling overhead and may increase the complexity of PDCCH monitoring of the terminal.

As a method different from the above-described method, transmission of periodic traffic may be performed by semi-persistent scheduling (SPS). A transmission resource of a data channel (e.g., PDSCH or PUSCH) may be periodically configured, and the terminal may periodically perform a reception operation or transmission operation of a data channel (e.g., PDSCH or PUSCH) in the configured resource. In the case of downlink transmission, the terminal may receive SPS PDSCH configuration information for periodic PDSCH transmission from the base station. The SPS PDSCH configuration information may include PDSCH resource information and/or scheduling information. For example, the SPS PDSCH configuration information may include at least one of information on one or more PDSCH time-frequency resource(s), information on an SPS resource periodicity (or SPS periodicity), information on the number of SPS PDSCH resources in each period, information on the number of repetitions of PDSCH transmission, MCS, redundancy version (RV), RV pattern, PDSCH mapping type, DM-RS type, DM-RS antenna port, or information on the number of transmission layers. In the case of uplink transmission, the terminal may receive configured grant (CG)-PUSCH configuration information for periodic PUSCH transmission from the base station. The CG-PUSCH configuration information may include PUSCH resource information and/or scheduling information. For example, the CG-PUSCH configuration information may include at least one of information on one or more PUSCH time-frequency resource(s), information on a CG-PUSCH resource periodicity, information on the number of CG PUSCH resources in each period, information on the number of repetitions of PUSCH transmission, MCS, RV, RV pattern, PUSCH mapping type, DM-RS type, DM-RS antenna port(s), or information on the number of transmission layers. In the present disclosure, the SPS PDSCH resource periodicity, SPS resource periodicity, and SPS period may be used in equivalent meanings, and the CG-PUSCH resource periodicity, CG resource periodicity, and CG period may be used in equivalent meanings. According to the above-described method, scheduling information of a data channel may be configured to the terminal through a semi-static signaling procedure (e.g., RRC signaling procedure), and a dynamic signaling procedure for transmitting scheduling DCI may be omitted. Therefore, according to the above-described method, control signaling overhead and PDCCH monitoring complexity of the terminal may be reduced compared to the DRX-based periodic traffic transmission method described in the above-described exemplary embodiment.

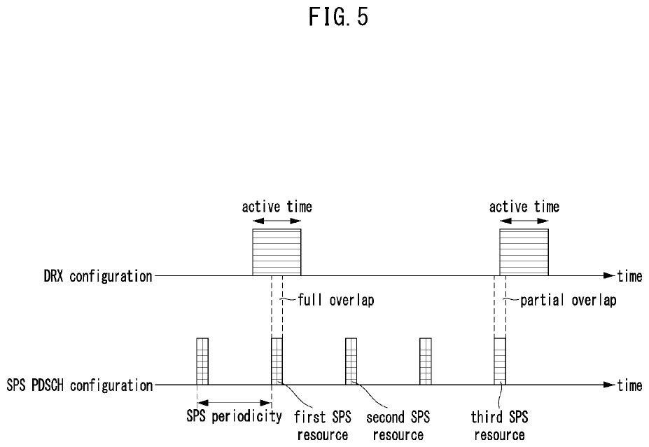

FIG. 5 is a conceptual diagram illustrating a first exemplary embodiment of a periodic traffic transmission method based on SPS PDSCH configuration.

Referring to FIG. 5, the terminal may receive DRX configuration information from the base station, and perform a PDCCH monitoring operation in an active time of each DRX cycle. In addition, the terminal may receive SPS PDSCH configuration information from the base station, and may receive (or monitor) PDSCHs in PDSCH resources that appear periodically and repeatedly. There may be no association relationship between the DRX cycle (or periodicity) and the SPS period (or periodicity). For example, the DRX cycle may be set to a relatively long cycle for a general low-power PDCCH monitoring operation of the terminal. On the other hand, the SPS period may be set to correspond to an occurrence (or arrival) periodicity of specific traffic (e.g., XR traffic) for periodic transmission of the specific traffic (e.g., XR traffic). According to an exemplary embodiment, the SPS period (or periodicity) may be shorter than the DRX cycle (or periodicity).

Referring to FIG. 5, the periodically repeated SPS resources may include a first SPS resource, a second SPS resource, and a third SPS resource. Among the SPS resources, a certain SPS resource (e.g., first SPS resource) may be located within an active time. In addition, another SPS resource (e.g., second SPS resource) may be located outside an active time. In addition, another SPS resource (e.g., third SPS resource) may partially overlap an active time, and only a portion of the another SPS resource may be located within the active time. The terminal may receive (or monitor) a PDSCH in an SPS resource arranged within the active time. In addition, the terminal may receive (or monitor) a PDSCH in an SPS resource arranged outside the active time. When a certain SPS resource is partially included in an active time, the terminal may receive (or monitor) a PDSCH in the SPS resource. For example, the SPS resource may be mapped to a first symbol and a second symbol. The first symbol may belong to a period outside the active time, and the second symbol may belong to the active time. Alternatively, the first symbol may belong to the active time, and the second symbol may belong to a period outside the active time. The terminal may perform a PDSCH reception operation in the SPS resource. The above-described mapping of the SPS resource may occur when the active time starts in the middle of a slot or when the active time ends in the middle of a slot. Alternatively, the terminal may consider the SPS resource partially overlapping with the active time as invalid, and may skip a PDSCH reception operation in the SPS resource. In the present disclosure, an SPS resource may refer to an SPS PDSCH resource, and an SPS configuration may refer to an SPS PDSCH configuration. In addition, in the present disclosure, a CG resource may mean a CG-PUSCH resource, and a CG configuration may mean a CG-PUSCH configuration.

[SPS HARQ-ACK Reporting]

The terminal may report HARQ-ACK, which is a reception response to an SPS PDSCH, to the base station. When the terminal successfully receives a PDSCH (or TB(s) included in the PDSCH) in an SPS resource, the terminal may transmit ACK to the base station as a response to the PDSCH. On the other hand, when the terminal fails to receive a PDSCH (or TB(s) included in the PDSCH) in the SPS resource, the terminal may transmit NACK to the base station as a response to the PDSCH. In the present disclosure, HARQ-ACK, which is a reception response to an SPS PDSCH, may be referred to as SPS HARQ-ACK. In an exemplary embodiment, SPS HARQ-ACK may refer to HARQ-ACK for a PDSCH transmitted in an SPS resource or HARQ-ACK for an SPS initial transmission PDSCH. In another exemplary embodiment, SPS HARQ-ACK may refer to HARQ-ACK for an SPS initial transmission PDSCH and HARQ-ACK for an SPS retransmission PDSCH. When NACK is received from the terminal, the base station may schedule a retransmission PDSCH for a PDSCH (or corresponding TB(s)) having been transmitted in the SPS resource to the terminal, and transmit the retransmission PDSCH to the terminal. The retransmission PDSCH may be dynamically scheduled by DCI. The DCI may have a CRC scrambled with a configured scheduling (CS)-RNTI.

The terminal may receive from the base station information on an uplink resource is which PDSCH HARQ-ACK is to be transmitted. For example, the uplink resource may be a PUCCH, and the information on the uplink resource may be a PUCCH resource indicator. In addition, the terminal may receive information on a transmission time of the HARQ-ACK from the base station. For example, the terminal may receive, from the base station, configuration information on a transmission slot (or subslot, mini-slot, or symbol) of the PUCCH on which the HARQ-ACK is to be transmitted. The transmission slot of the PUCCH may be determined based on a reception slot (or subslot, mini-slot, or symbol) of the PDSCH corresponding to the PUCCH. Configuration information on a distance (e.g., slot distance or the number of slots) between the transmission slot of the PUCCH and the reception slot of the PDSCH corresponding to the PUCCH may be transmitted to the terminal. For example, the configuration information may refer to ‘PDSCH-HARQ feedback timing’ or ‘PDSCH-HARQ feedback timing indicator’. When the uplink resource configured by the base station is valid, the terminal may transmit HARQ-ACK in the corresponding uplink resource. When the uplink resource configured by the base station is not valid, the terminal may transmit HARQ-ACK in a different uplink resource (e.g., different PUCCH resource or PUSCH resource) and/or at a different time (e.g., different slot, subslot, symbol, or the like after the transmission slot of the PUCCH) based on a predefined rule or additional configuration from the base station.

In the present disclosure, an uplink resource may refer to a resource through which the terminal transmits an uplink signal and/or a channel. An uplink resource may not refer to only a resource whose transmission direction is set to uplink. For example, an uplink resource may refer to not only a resource mapped to uplink symbol(s) but also a resource mapped to flexible symbol(s) (i.e., symbol(s) usable for both downlink transmission and uplink transmission). In some cases, an uplink resource may refer to a resource mapped to downlink symbol(s).

The SPS HARQ-ACK may be transmitted as being multiplexed with another HARQ-ACK. That is, the SPS HARQ-ACK may be included in the same HARQ-ACK codebook together with the another HARQ-ACK, and the corresponding HARQ-ACK codebook may be transmitted in the same uplink resource. The another HARQ-ACK may include HARQ-ACK for a PDSCH dynamically scheduled by DCI, HARQ-ACK for a PDSCH transmitted in a resource other than an SPS resource, HARQ-ACK for DCI, and/or HARQ-ACK for DCI indicating SPS release. Specifically, the SPS HARQ-ACK may be mapped to the same HARQ-ACK codebook together with HARQ-ACK(s) for PDSCH(s) (or PDSCH candidate(s) or PDSCH occasion (s)) having a slot in which the SPS HARQ-ACK is transmitted as an HARQ-ACK transmission time.

Meanwhile, several methods of configuring the HARQ-ACK codebook may be considered. First, an HARQ-ACK codebook (hereinafter referred to as ‘Type 1 HARQ-ACK codebook’) having a fixed (or semi-static) size may be considered. In this case, the terminal may estimate HARQ-ACK(s) that are likely to be transmitted at a specific time (e.g., specific slot, specific subslot) from candidate TB(s) that are likely to be scheduled from the base station (e.g., candidate TB(s) that are likely to be received), map the estimated HARQ-ACK(s) to an HARQ-ACK codebook, and transmit the HARQ-ACK codebook at the specific time. Each candidate TB may be transmitted on one or more PDSCH(s). One or more PDSCH(s) corresponding to one TB may be referred to as ‘candidate PDSCH reception’, ‘candidate PDSCH occasion’, ‘PDSCH occasion’, and/or the like. One HARQ-ACK for each PDSCH occasion may be mapped to one bit within the codebook. When the number of MIMO transmission layers is greater than or equal to a reference value (e.g., 5), one PDSCH may include a plurality (e.g., two) TBs. In this case, for each PDSCH occasion, n HARQ-ACKs may be mapped to n bits within the codebook. n may be an integer of 2 or more. In an exemplary embodiment, a case when the number of MIMO transmission layers is less than the reference value (e.g., a case when one PDSCH includes one TB) may be assumed. The proposed method may be equally applied even when one PDSCH includes a plurality of TBs. When repeated PDSCH transmission is used for a certain TB, a HARQ-ACK timing of the TB may be defined based on a transmission time of the last PDSCH of the corresponding PDSCH occasion. The PDSCH occasions mapped to the same HARQ-ACK codebook may be simultaneously received by the terminal. For example, time resources (e.g., symbols) of the PDSCH occasions mapped to the same HARQ-ACK codebook may not overlap each other. At least some of the above-described PDSCH occasions may be SPS PDSCHs, and the SPS PDSCHs may be semi-persistently scheduled PDSCHs by an SPS configuration and/or DCI.

Next, an HARQ-ACK codebook (hereinafter referred to as ‘Type 2 HARQ-ACK codebook’) having a dynamically variable size may be considered. In this case, the terminal may map HARQ-ACK(s) for TB(s) scheduled by DCI(s) to bit(s) of the Type 2 HARQ-ACK codebook. When HARQ-ACKs corresponding to a plurality of DCIs are included in one HARQ-ACK codebook, an order in which the HARQ-ACKs corresponding to the plurality of DCIs are mapped to a payload within the HARQ-ACK codebook may be determined according to time resources (e.g., start symbols) and serving cells of PDCCH monitoring occasions (or CORESETs, search space sets) in which the DCIs are transmitted. For example, PDCCH monitoring occasions having the same start symbol among the PDCCH monitoring occasions corresponding to the same HARQ-ACK codebook may be indexed in ascending order (or descending order) of cell IDs (e.g., physical layer cell IDs or IDs separately assigned by higher layer configuration) of the serving cells, and then the PDCCH monitoring occasions may be indexed in an order of earlier start symbols. The HARQ-ACKs may be mapped to bits within the HARQ-ACK codebook in the order of the indexes. The base station may transmit a DCI format in up to one PDCCH monitoring occasion for each start symbol in each serving cell. The mapping order of the HARQ-ACKs may be determined by further considering locations of time resources (e.g., start symbols) of the PDSCHs corresponding to the HARQ-ACKs. The terminal may map SPS HARQ-ACK(s) to bit(s) of the Type 2 HARQ-ACK codebook. The SPS HARQ-ACK(s) may be mapped to the same HARQ-ACK codebook together with the HARQ-ACK(s) for the TB(s) scheduled by the DCI(s), and the corresponding HARQ-ACK codebook may be transmitted in the same uplink resource.

An HARQ-ACK codebook for feeding back HARQ-ACK(s) for a plurality of downlink HARQ processes (e.g., all downlink HARQ processes) at once (hereinafter referred to as ‘Type 3 HARQ-ACK codebook’) may be considered. The base station may configure a set of HARQ processes constituting the Type 3 HARQ-ACK codebook to the terminal. The terminal may identify the set of HARQ processes configured by the base station. An HARQ-ACK reporting operation of the terminal, which uses the HARQ-ACK codebook, may be indicated or triggered by DCI (e.g., downlink DCI, DCI format 1_0, 1_1, 1_2, or the like).

Meanwhile, a plurality of PDSCHs may be transmitted through a plurality of SPS resources within one SPS period for one SPS configuration, and a plurality of TBs may be transmitted through the plurality of PDSCHs. In this case, SPS HARQ-ACKs corresponding to the plurality of TBs may be reported to the base station. In this case, the terminal may receive configuration information on one PDSCH-HARQ feedback timing for the SPS configuration, and the one PDSCH-HARQ feedback timing may be commonly applied to all SPS resources allocated by the SPS configuration.

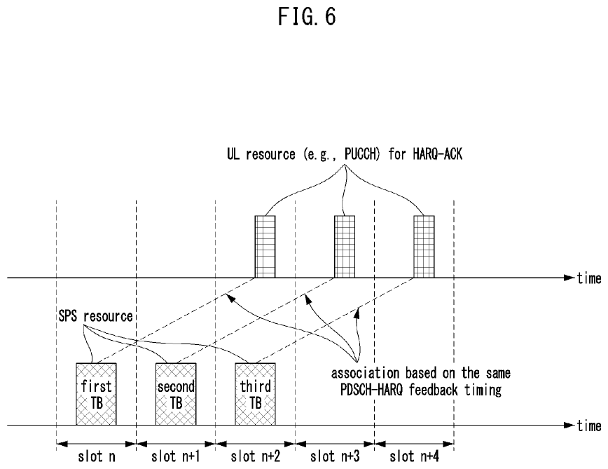

FIG. 6 is a conceptual diagram illustrating a first exemplary embodiment of a method for configuring uplink resources for SPS HARQ-ACK transmission.

Referring to FIG. 6, the base station may transmit information of an SPS configuration to the terminal, and the terminal may receive the information of the SPS configuration from the base station. According to the SPS configuration, at least three SPS resources may be allocated to the terminal, and the three SPS resources may belong to the same SPS period. The terminal may receive three PDSCHs respectively including a first TB, a second TB, and a third TB in the three SPS resources, and may transmit HARQ-ACKs for the three PDSCHs (e.g., three TBs) to the base station. In this case, information on one HARQ feedback transmission time (e.g., the same or common PDSCH-HARQ feedback timing) configured for the SPS configuration may be equally applied to the three PDSCHs according to the above-described method. For example, when a PDSCH-HARQ feedback timing value configured to the terminal is 2, the terminal may determine a distance between a reception slot of the PDSCH and a transmission slot of the corresponding HARQ-ACK as 2 slots based on the PDSCH-HARQ feedback timing value (i.e., 2). The terminal may determine a transmission slot of the HARQ-ACK for the first TB received in a slot n as a slot (n+2), determine a transmission slot of the HARQ-ACK for the second TB received in a slot (n+1) as a slot (n+3), and determine a transmission slot of the HARQ-ACK for the third TB received in the slot (n+2) as a slot (n+4). The terminal may transmit the HARQ-ACKs in the determined transmission slots, respectively.

According to the above-described exemplary embodiment, the terminal may transmit each HARQ-ACK corresponding to each TB to the base station at an earliest possible time, and the base station may perform retransmission of a TB corresponding to NACK at an earliest possible time. However, according to the above-described exemplary embodiment, since a separate SPS HARQ-ACK transmission resource is determined for each unit time (e.g., each slot), there may be a disadvantage in that a plurality of uplink transmissions are performed for transmission of the SPS HARQ-ACKs. In exemplary embodiments below, methods for solving the above-described problem will be described.

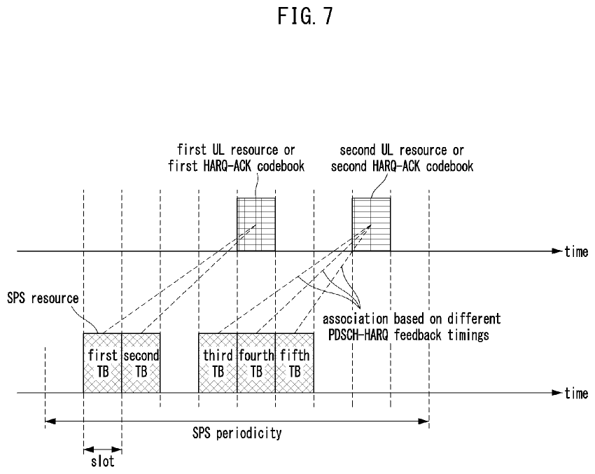

FIG. 7 is a conceptual diagram illustrating a second exemplary embodiment of a method for configuring uplink resources for SPS HARQ-ACK transmission.

Referring to FIG. 7, the base station may transmit information of an SPS configuration to the terminal, and the terminal may receive the information of the SPS configuration from the base station. According to the SPS configuration, at least five SPS resources may be allocated to the terminal, and the five SPS resources may belong to the same SPS period. The terminal may receive five PDSCHs respectively including a first TB to a fifth TB in the five SPS resources, and may transmit HARQ-ACKs for the five PDSCHs (e.g., five TBs) to the base station.

The base station may transmit configuration information on an association relationship between the SPS resources and HARQ-ACK transmission resources corresponding to the SPS resources to the terminal. The terminal may receive the configuration information on the association relationship from the base station. The configuration information on the association relationship may include information on a distance (e.g., slot distance) between a slot to which each SPS resource is mapped and a slot to which each HARQ-ACK transmission resource corresponding to each SPS resource is mapped. The slot distance may be set to a different value for each of the plurality of SPS resources. The slot distance between the SPS resource in which the first TB is received and a first uplink resource (e.g., first UL resource) that is the HARQ-ACK transmission resource corresponding to the SPS resource may be 4. The slot distance between the SPS resource in which the second TB is received and the first uplink resource (i.e., first UL resource) that is the HARQ-ACK transmission resource corresponding to the SPS resource may be 3. In addition, one or more SPS resources may form an SPS resource group (or SPS PDSCH group), and an HARQ-ACK transmission resource may be configured for each SPS resource group. The two SPS resources in which the first TB and the second TB are respectively received may belong to a first SPS resource group, and the first SPS resource group may be associated with the first uplink resource or a first HARQ-ACK codebook. The terminal may transmit HARQ-ACKs for the first SPS resource group using the first uplink resource and/or the first HARQ-ACK codebook based on the association relationship (e.g., mutual association relationship). The three SPS resources in which the third TB to the fifth TB are respectively received may belong to a second SPS resource group, and the second SPS resource group may be associated with a second uplink resource or a second HARQ-ACK codebook. The terminal may transmit HARQ-ACKs for the second SPS resource group using the second uplink resource and/or the second HARQ-ACK codebook based on the association relationship (e.g., mutual association relationship).

The configuration information on the association relationship may include information on HARQ-ACK transmission resources. For example, the HARQ-ACK transmission resource may be a PUCCH, and the terminal may receive PUCCH resource allocation information or information indicating a preconfigured PUCCH resource (e.g., PUCCH resource indicator) from the base station. Information on the HARQ-ACK transmission resources may be configured for each SPS resource group. Configuration information of the first uplink resource corresponding to the first SPS resource group and configuration information of the second uplink resource corresponding to the second SPS resource group may be configured to the terminal.

The HARQ-ACK codebook (e.g., the first HARQ-ACK codebook or the second HARQ-ACK codebook) may include not only SPS HARQ-ACK(s) but also other HARQ-ACK(s) (e.g., HARQ-ACK(s) for PDSCH occasion(s) associated with the uplink slot in which the HARQ-ACK codebook is transmitted. The size of a payload of the HARQ-ACK codebook may be determined by not only the number of the SPS resources and/or the number of the TBs but also the number of the PDSCH occasions associated with the uplink slot in which the HARQ codebook is transmitted. The terminal may map HARQ-ACK bits corresponding to the PDSCH occasions to the HARQ-ACK codebook regardless of whether PDSCHs are received in the PDSCH occasions. The size of the HARQ-ACK codebook may be maintained.

Meanwhile, when an SPS resource is arranged outside a DRX active time, the terminal may not receive a dynamic scheduling outside the DRX active time, and thus the terminal may not receive PDSCHs in PDSCH occasions sharing an HARQ-ACK transmission slot together with the SPS resource. According to the above-described method, since the terminal still needs to map HARQ-ACKs corresponding to the SPS resource to the HARQ-ACK codebook together with HARQ-ACKs for the PDSCH occasions, there may exist a disadvantage that an HARQ-ACK codebook having an unnecessarily large size should be transmitted.

As a method for solving the above-described problem, the terminal may configure an HARQ-ACK codebook including only SPS HARQ-ACK(s), and transmit the HARQ-ACK codebook to the base station through an uplink resource (e.g., PUCCH, PUSCH). The above-described method may be applied when the terminal is configured to use the Type 1 HARQ-ACK codebook. When a predetermined condition is satisfied, the terminal may configure an HARQ-ACK codebook including only SPS HARQ-ACK(s) without using the Type 1 HARQ-ACK codebook, and transmit the corresponding HARQ-ACK codebook to the base station. The SPS HARQ-ACK(s) may be HARQ-ACK(s) for all SPS resource(s) associated with the corresponding uplink resource. In a certain case (e.g., when repeated SPS PDSCH transmission is configured), the number of SPS resource(s) and the number of HARQ-ACK(s) may not necessarily match. For example, the size of the HARQ-ACK codebook may be determined by the number of TB(s) transmitted in the associated SPS resource(s) or the number of HARQ process(es) therefor.

The predetermined condition may refer to a condition determined by a location of the resource in which the HARQ-ACK codebook is to be transmitted. Additionally or alternatively, the predetermined condition may refer to a condition determined by location(s) of the associated SPS resource(s). For example, the predetermined condition may include a condition regarding whether an HARQ-ACK codebook transmission resource and/or the SPS resource(s) are included within a DRX active time. The predetermined condition may be a condition that PDSCH(s) received by the terminal include only SPS PDSCH(s) and do not include PDSCH(s) other than the SPS PDSCH(s). The PDSCH(s) received by the terminal may mean PDSCH(s) or PDSCH occasion(s) whose HARQ-ACK transmission timing coincides with the HARQ-ACK codebook transmission resource.

In the above-described method, SPS resources constituting the same HARQ-ACK codebook (e.g., SPS resources belonging to the same SPS resource group) may belong to the same SPS period. The base station may configure SPS HARQ-ACK timing related information to the terminal such that HARQ-ACK transmission times (e.g., transmission slots) of SPS resources corresponding to different SPS periods do not coincide. Accordingly, the terminal may not expect to perform an operation of mapping SPS resources corresponding to different SPS periods to the same HARQ-ACK codebook or the same uplink resource.

The above-described HARQ-ACK codebook may not include HARQ-ACK for an SPS PDSCH on which the terminal has not performed a reception operation. That is, the HARQ-ACK codebook may include only HARQ-ACK(s) for SPS PDSCH(s) on which the terminal has actually performed a reception operation. For example, the SPS PDSCH on which the terminal has not performed a reception operation may be an SPS PDSCH for which a reception operation has been skipped due to an overlap with an uplink symbol, an overlap with another PDSCH, a low priority, a PDSCH reception capability limit of the terminal, and/or the like. For example, a first SPS resource and a second SPS resource may be mapped to the same slot. The first SPS resource and the second SPS resource may be SPS resources allocated by different SPS configurations. In this case, the first SPS resource and the second SPS resource may overlap each other in the same symbol. The terminal may select one SPS resource (e.g., first SPS resource) having a higher priority among the overlapping SPS resources, and perform a PDSCH reception operation in the selected SPS resource (e.g., first SPS resource). The terminal may skip a PDSCH reception operation in the unselected SPS resource (e.g., second SPS resource). For example, the priority of the SPS resource may be determined based on an index of an SPS configuration corresponding to the SPS resource. An index (or number) of the SPS configuration corresponding to the first SPS resource may be lower (or higher) than an index (or number) of the SPS configuration corresponding to the second SPS resource. In this case, the terminal may map HARQ-ACK for a PDSCH transmitted in the first SPS resource to the HARQ-ACK codebook according to the above-described method, and may not map HARQ-ACK for a PDSCH transmitted in the second SPS resource to the HARQ-ACK codebook.

However, according to the above-described method, the size of the HARQ-ACK codebook may be dynamically changed. For example, the terminal may determine validity of an SPS resource according to a slot format dynamically indicated by DCI received from the base station, and whether HARQ-ACK corresponding to the SPS resource is mapped may be determined depending on whether the SPS resource is valid or not. Accordingly, the size of the SPS HARQ-ACK codebook may be variable, and a transmission reliability of the HARQ-ACK codebook may decrease according to a DCI reception performance of the terminal. As a method for solving the above-described problem, the terminal may map not only HARQ-ACK(s) corresponding to SPS resources on which a PDSCH reception operation has been performed but also HARQ-ACKs corresponding to SPS resources on which a PDSCH reception operation has not been performed to the HARQ-ACK codebook, and transmit the corresponding HARQ-ACK codebook to the base station. In this case, the terminal may determine HARQ-ACK corresponding to the SPS resource on which a PDSCH reception operation has not been performed as NACK. A mapping order of the HARQ-ACKs corresponding to the SPS resources may be determined according to a predetermined rule (e.g., locations of the SPS resources, a carrier or serving cell to which the SPS resource is mapped, an index of the SPS configuration corresponding to the SPS resource, and/or the like).

When the SPS HARQ-ACK transmission resource configured by the above-described method is not valid, the terminal may transmit the SPS HARQ-ACK in another uplink resource (e.g., another valid uplink resource) appearing after the invalid resource. For example, the another (i.e., new) uplink resource may be one SPS HARQ-ACK transmission resource (e.g., the earliest SPS HARQ-ACK transmission resource) appearing after the SPS HARQ-ACK transmission resource. The new SPS HARQ-ACK transmission resource may be a resource having an HARQ-ACK feedback timing relationship with other SPS resource(s) (or another SPS resource group).

The new SPS HARQ-ACK transmission resource replacing the invalid resource may satisfy a predetermined condition. For example, the new SPS HARQ-ACK transmission resource may be limited to a resource for HARQ-ACK feedback of the same SPS configuration as the invalid resource. Additionally or alternatively, the new HARQ-ACK transmission resource may be a resource corresponding to SPS resources of the same SPS period as the invalid resource. That is, the new HARQ-ACK transmission resource may be an HARQ-ACK transmission resource for SPS resource(s) within the same SPS period as the SPS resource corresponding to the SPS HARQ-ACK. In the second exemplary embodiment, the terminal may transmit the HARQ-ACKs corresponding to the first TB and the second TB in the second uplink resource when the first uplink resource is not valid. The first uplink resource and the second uplink resource may be resources for transmitting HARQ-ACKs for SPS resources belonging to the same SPS period. The HARQ-ACKs corresponding to the first TB and the second TB may be mapped to the same HARQ-ACK codebook (i.e., the second HARQ-ACK codebook) as that of the HARQ-ACKs corresponding to the third TB to fifth TB, and the corresponding HARQ-ACK codebook may be transmitted in the second uplink resource.

In this case, HARQ-ACKs additionally having a mapping relationship with the HARQ-ACK codebook (i.e., HARQ-ACKs corresponding to the first TB and the second TB) may be mapped in a later order (or to bit(s) closer to the least significant bit (LSB)) than the HARQ-ACKs (i.e., HARQ-ACKs corresponding to the third to fifth TBs) originally mapped within the payload of the HARQ-ACK codebook. Alternatively, the HARQ-ACK bits may be determined based on a temporal order of the SPS resources, indexes of the SPS resources, indexes of the SPS configurations corresponding to the SPS resources, and/or the like without the above-described distinction. In an exemplary embodiment, HARQ-ACKs of the earlier SPS resources may be mapped to the HARQ-ACK codebook in an earlier order than HARQ-ACKs of the later SPS resources.

Alternatively, the new HARQ-ACK transmission resource may be a time resource belonging to a certain time range (e.g., time window) from the invalid resource. For example, the new HARQ-ACK transmission resource may a resource mapped to one of L slots (or subslots or subframes) appearing after the slot (or subslot or subframe) to which the invalid resource is mapped. L may be a natural number. The terminal may calculate a temporal distance (e.g., the number of slots) between a certain candidate HARQ-ACK transmission resource and the invalid resource, and when the calculated temporal distance is less than a reference value or a configured value, the terminal may regard the candidate HARQ-ACK transmission resource as the new HARQ-ACK transmission resource, and transmit the SPS HARQ-ACK mapped to the invalid resource in the new HARQ-ACK transmission resource.

The terminal may fail to find a new HARQ-ACK transmission resource that satisfies the predetermined condition described above. In this case, the terminal may drop the SPS HARQ-ACK to be transmitted (i.e., the SPS HARQ-ACK to be transmitted in the invalid resource). That is, the terminal may give up transmission of the SPS HARQ-ACK. In the second exemplary embodiment, when the second uplink resource is not valid, the terminal may fail to find a new HARQ-ACK transmission resource corresponding to the same SPS period or a new HARQ-ACK transmission resources belonging to the time window. In this case, the terminal may drop transmission of the HARQ-ACKs corresponding to the third TB to the fifth TB in the second uplink resource. According to the above-described method, the base station may not transmit retransmission PDSCHs for the third to fifth TBs to the terminal. When the terminal does not successfully receive at least one TB among the third TB to fifth TB, transmission of the at least one TB may fail.

As a method for solving the above-described problem, the base station may instruct the terminal to perform SPS HARQ-ACK feedback through separate signaling. An uplink resource for the SPS HARQ-ACK feedback may be another uplink resource other than the above-described SPS HARQ-ACK transmission resource. For example, the uplink resource may be a PUSCH. The base station may dynamically allocate a PUSCH to the terminal through DCI, and may instruct the terminal to transmit SPS HARQ-ACK through the PUSCH. Alternatively, the uplink resource may be a PUCCH. The base station may dynamically allocate the PUCCH to the terminal through DCI, and may instruct the terminal to transmit SPS HARQ-ACK through the PUCCH. Information on the uplink resource may be preconfigured in the terminal. Alternatively, the information on the uplink resource may be included in DCI transmitted to the terminal.

The uplink resource may belong to a serving cell or an uplink carrier (hereinafter referred to as ‘PUCCH cell’) in which the terminal is configured to perform PUCCH transmission. Alternatively, the uplink resource may be a resource allocated to a serving cell or an uplink carrier different from the PUCCH cell. That is, the terminal may switch the PUCCH cell to transmit SPS HARQ-ACK to the base station, and may transmit the SPS HARQ-ACK in an uplink resource (e.g., PUCCH or PUSCH) allocated to the switched PUCCH cell. The above-described method may be used when it is difficult to find a valid uplink resource in the originally configured PUCCH cell. For example, when an uplink resource configured to transmit SPS HARQ-ACK is not valid and/or when a new HARQ-ACK transmission resource to replace the uplink resource is not found, the terminal may switch a cell in which the PUCCH is to be transmitted from a first PUCCH cell to a second PUCCH cell, and transmit the SPS HARQ-ACK in a valid SPS HARQ-ACK transmission resource of the second PUCCH cell. In order to support this operation, the terminal may receive in advance configuration information of an SPS HARQ-ACK transmission resource (or candidate SPS HARQ-ACK transmission resource) for each of the first PUCCH cell and the second PUCCH cell from the base station. The first PUCCH cell and the second PUCCH cell may be configured to the terminal through a signaling procedure (e.g., RRC signaling procedure). One of the PUCCH cells to which the PUCCH cell switching operation is applied may operate as a reference cell. The terminal may transmit the PUCCH or HARQ-ACK in the reference cell as a default operation. In the above example, the reference cell may be the first PUCCH cell.

When SPS transmission is performed outside a DRX active time, the terminal may not perform a PDCCH monitoring operation for receiving the DCI. Therefore, the base station may configure a separate PDCCH resource (e.g., PDCCH monitoring resource, search space set(s)) for the terminal to monitor the DCI in the terminal. The separate PDCCH monitoring resource may always be monitored regardless of a DRX active time. The DCI may be monitored outside a DRX active time. The separate PDCCH monitoring resource may be the same as a separate PDCCH monitoring resource for SPS retransmission scheduling to be described later.

When a plurality of SPS configurations are configured to the terminal, the above-described method may be applied to each SPS configuration. The same PUCCH cell may be configured for the plurality of SPS configurations. That is, HARQ-ACKs for the plurality of SPS configurations may be transmitted in the same serving cell or the same uplink carrier. Meanwhile, HARQ-ACK transmission timings of SPS resources according to different SPS configurations may be determined as the same slot (or subslot, subframe, or the like). In this case, the terminal may map HARQ-ACKs for the SPS resources to the same HARQ-ACK codebook. The HARQ-ACK codebook may be transmitted through the same uplink resource in the slot (or subslot, subframe, or the like). The above-described method may be used only when PUCCH cells (e.g., HARQ-ACK feedback transmission cells) of the different SPS configurations are the same. Alternatively, the above-described method may be used even when the PUCCH cells (e.g., HARQ-ACK feedback transmission cells) of the different SPS configurations are different from each other. For example, a first PUCCH cell and a second PUCCH cell may be configured for a first SPS configuration and a second SPS configuration, respectively, and the terminal may map HARQ-ACKs for the first SPS configuration and the second SPS configuration to the same HARQ-ACK codebook, and may transmit the corresponding HARQ-ACK codebook. In this case, the terminal may select one of the first PUCCH cell and the second PUCCH cell. The terminal may transmit the HARQ-ACK codebook in the selected PUCCH cell. In a case different from the above-described exemplary embodiment, HARQ-ACK for each SPS configuration may be transmitted through each associated PUCCH cell.

The size of the above-described HARQ-ACK codebook may be determined by the number of SPS HARQ-ACK bit(s). When the above-described HARQ-ACK codebook includes only SPS HARQ-ACK(s), the size of the HARQ-ACK codebook may be determined as the number of SPS HARQ-ACK bit(s) for the SPS resource(s) associated with the HARQ-ACK codebook. The above-described HARQ-ACK codebook may additionally include information other than HARQ-ACKs. For example, the above-described HARQ-ACK codebook may include a new data indicator (NDI) for the corresponding TB(s) or HARQ process(es). In this case, when a plurality of PDSCHs are received for the same TB or the same HARQ process, the terminal may determine the NDI based on the most-recently received PDSCH.

The above-described method may be equally applied to not only transmission of HARQ-ACK for a PDSCH transmitted in the SPS resource but also transmission of HARQ-ACK for an SPS retransmission PDSCH. For example, the terminal may identify scheduling information of a PDSCH through reception of DCI having a CRC scrambled with a CS-RNTI, and map HARQ-ACK for the PDSCH to the above-described separate SPS HARQ-ACK codebook, and transmit the SPS HARQ-ACK codebook to the base station through the above-described method.

Meanwhile, even when the base station receives NACK in response to the SPS PDSCH from the terminal, it may be difficult to transmit a retransmission PDSCH for the SPS PDSCH to the terminal until the next active time of the terminal. When the SPS PDSCH includes a packet requiring a low-latency quality of service (QoS), reporting of HARQ-ACK for the SPS PDSCH to the base station by the terminal may not be helpful for transmission, and a signaling overhead due to the reporting of the HARQ-ACK may increase.

Accordingly, the HARQ-ACK feedback operation of the terminal for the SPS PDSCH may be skipped. The terminal may skip an HARQ-ACK feedback operation for specific traffic. In order to support this operation, the base station may enable or disable the HARQ-ACK feedback operation for each SPS configuration in the terminal. The terminal may identify whether the HARQ-ACK feedback operation is performed based on the configuration of the base station. The terminal may generate HARQ-ACK for reception of an SPS PDSCH according to an SPS configuration configured to perform HARQ-ACK feedback, and may report the HARQ-ACK to the base station based on the above-described method. On the other hand, the terminal may not perform a HARQ-ACK generation operation and/or transmission operation for reception of an SPS PDSCH by an SPS configuration configured not to perform HARQ-ACK feedback. The above-described SPS configuration may mean an activated SPS configuration, and the meaning of the SPS configuration may be applied throughout the present disclosure.

[SPS Retransmission PDCCH Configuration]

In an SPS resource, transmission of a PDSCH (or TB(s) included in the PDSCH) may be initial transmission. When the terminal fails to receive the PDSCH in the SPS resource, the PDSCH (or TB(s) included in the PDSCH) may be retransmitted.

In FIG. 8, a case (a) corresponds to a first exemplary embodiment of an SPS PDSCH retransmission method, and a case (b) corresponds to a second exemplary embodiment of an SPS PDSCH retransmission method.

Referring to the cases (a) and (b) of FIG. 8, the terminal may decode (or demodulate or monitor) a PDSCH (i.e., SPS PDSCH) in an SPS resource. Referring to the case (a) of FIG. 8, the SPS resources may be arranged within an active time. In this case, a time after the terminal performs an operation of receiving the SPS PDSCH or a time after the terminal transmits HARQ-ACK corresponding to the SPS PDSCH may still belong to the active time. The base station may transmit DCI for scheduling a retransmission PDSCH in a search space set monitored by the terminal in the active time, and may transmit the retransmission PDSCH to the terminal. That is, retransmission of the SPS PDSCH may be performed quickly. On the other hand, referring to the case (b) of FIG. 8, the SPS resource may be arrange outside the active time. In this case, in a time from after the terminal performs the operation of receiving the SPS PDSCH or after the terminal transmits the HARQ-ACK corresponding to the SPS PDSCH until the terminal enters an active time of the next DRX cycle, the terminal may not perform a PDCCH monitoring operation. Therefore, the base station may not be able to transmit DCI (i.e., DCI for scheduling a retransmission PDSCH) to the terminal until the active time of the next DRX cycle of the terminal starts. Therefore, the base station may not be able to transmit the retransmission PDSCH to the terminal until the active time of the next DRX cycle. As a result, a time delay for retransmission of the SPS PDSCH may increase, and transmission of traffic requiring low-latency characteristics may fail.

As a method for solving the above-described problem, the base station may configure a separate PDCCH monitoring resource for SPS PDSCH retransmission to the terminal. The terminal may identify the separate PDCCH monitoring resource configured by the base station. The separate PDCCH monitoring resource may always be monitored regardless of a DRX active time. Alternatively, a separate PDCCH monitoring operation may be performed outside a DRX active time. Here, the PDCCH monitoring resource may mean search space set(s), CORESET(s), PDCCH monitoring occasion(s), PDCCH candidate(s), and/or the like. The PDCCH monitoring resource may be associated with the SPS resource. For example, the base station may configure search space set (s) (or CORESET(s), PDCCH monitoring occasion (s)) associated with an SPS configuration to the terminal. The terminal may identify the search space set(s) configured by the base station. When a plurality of SPS configurations are configured in the terminal, search space set(s) associated with each SPS configuration may be configured. Resources of the search space set(s) (or CORESET(s), PDCCH monitoring occasion(s)) for SPS retransmission may be determined based on SPS PDSCH resource(s) by the associated SPS configuration. The method described above may be referred to as (Method 100).

The PDCCH monitoring resource may be a dedicated resource for transmitting DCI scheduling a retransmission PDSCH of the SPS PDSCH. For example, the PDCCH monitoring resource may include one search space set (e.g., USS set). The terminal may monitor DCI (or DCI format) having a CRC scrambled with a CS-RNTI in the search space set. The terminal may additionally perform a monitoring operation based on a C-RNTI or MCS-C-RNTI for the same DCI format as the DCI in the search space set. The terminal may monitor DCI formats (e.g., group common DCI, DCI format 2_0, uplink scheduling DCI, DCI formats 0_0, 0_1, 0_2, and the like) other than that of the DCI in the search space set. For another example, the PDCCH monitoring resource may include a plurality of search space sets. The plurality of search space sets may include only USS set(s). Alternatively, the plurality of search space sets may include a CSS set and may be used for purposes other than PDSCH scheduling (e.g., for purposes of transmitting broadcast control information, paging information, information related to random access, and/or the like to the terminal).

Whether or not the terminal performs the PDCCH monitoring operation in the search space set(s) may be determined based on a reception operation in SPS PDSCH resource(s) or an HARQ-ACK transmission operation corresponding to the SPS PDSCH resource(s) according to the associated SPS configuration. For example, when the terminal successfully receives a PDSCH in the associated SPS resource or when the terminal transmits ACK for the PDSCH to the base station, the terminal may skip the PDCCH monitoring operation in the search space set(s) for SPS retransmission. On the other hand, when the terminal does not receive a PDSCH in the associated SPS resource, when the terminal transmits NACK for the PDSCH to the base station, or when the terminal does not transmit HARQ-ACK for the PDSCH to the base station, the terminal may perform a PDCCH monitoring operation in the search space set(s) for SPS retransmission, and expect to receive DCI scheduling an SPS retransmission PDSCH.

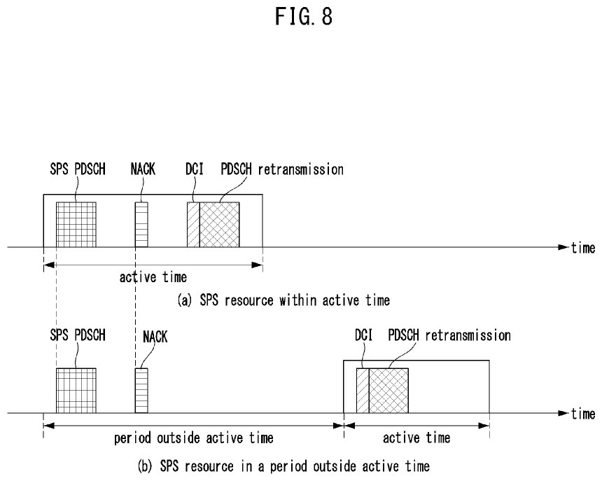

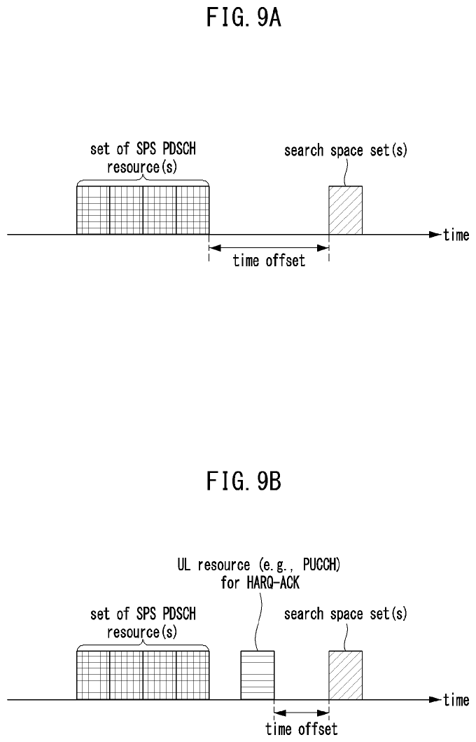

FIG. 9A is a conceptual diagram illustrating a first exemplary embodiment of a PDCCH monitoring resource configuration method for retransmission of an SPS PDSCH, and FIG. 9B is a conceptual diagram illustrating a second exemplary embodiment of a PDCCH monitoring resource configuration method for retransmission of an SPS PDSCH.

Referring to FIGS. 9A and 9B, the terminal may receive SPS resource configuration information from the base station, and one or more SPS resource(s) (i.e., SPS PDSCH resource(s)) may be periodically allocated to the terminal. According to (Method 100), the terminal may receive configuration information of search space set(s) associated with the SPS configuration or SPS resource(s) from the base station. In this case, resources of the search space set(s) may be determined based on the SPS resource(s).

Referring to FIG. 9A, symbol(s) (or slot(s)) in which the search space set(s) are arranged may be determined as a time after a predetermined time offset from symbol(s) (or slot(s)) where the SPS resource(s) are arranged. When a plurality of SPS resources are allocated in one SPS period, the location of the PDCCH monitoring resource(s) may be determined based on a symbol (e.g., the last symbol or the first symbol) to which one SPS resource (e.g., the latest SPS resource or the earliest SPS resource) among the plurality of SPS resources is mapped. The time offset may mean L1 symbol(s) (or duration corresponding to the L1 symbol(s)) or L2 slot(s) (or duration corresponding to the L2 slot(s)). The base station may configure the time offset to the terminal. For example, the base station may transmit SPS configuration information including information on the time offset to the terminal, and the terminal may identify the time offset based on the SPS configuration information received from the base station. The time offset may have a value greater than or equal to a reference value. The reference value may be M1 symbol(s) (or duration corresponding to the M1 symbol(s)) or M2 slot(s) (or duration corresponding to the M2 slot(s)). The reference value may be predefined in the technical specification. Alternatively, the base station may configure the reference value to the terminal. The reference value may correspond to a value including a time required for the terminal to determine whether PDSCH reception is successful in the SPS resource. The reference value may correspond to a value including a time required for the base station to receive HARQ-ACK corresponding to the PDSCH.

Referring to FIG. 9B, symbol(s) (or slot(s)) in which the search space set(s) are arranged may be determined as a time after a predetermined time offset from symbol(s) (or slot(s)) in which HARQ-ACK transmission resources corresponding to the SPS resource(s) are located. An uplink signal including the SPS HARQ-ACK may be repeatedly transmitted in a plurality of uplink resources, and in this case, the location of the PDCCH monitoring resource(s) may be determined based on a symbol (e.g., the last symbol or the first symbol) or slot to which one resource (e.g., the latest UL resource or the earliest UL resource) among the plurality of uplink resources is mapped. The time offset may mean L3 symbol(s) (or duration corresponding to the L3 symbol(s)) or L4 slot(s) (or duration corresponding to the L4 slot(s)). The base station may configure the time offset to the terminal. For example, the base station may transmit SPS configuration information including information on the time offset to the terminal. The time offset may be a value greater than or equal to a reference value. The reference value may be M3 symbol(s) (or duration corresponding to the M3 symbol(s)) or M4 slot(s) (or duration corresponding to the M4 slot(s)). The reference value may be predefined in the technical specification. Alternatively, the base station may configure the reference value to the terminal. The reference value may reflect a time required for the base station to determine whether reception of the uplink signal is successful.

According to the above-described exemplary embodiments, since HARQ retransmission (e.g., HARQ retransmission scheduling DCI) for a plurality of SPS resources is monitored through the same search space set, PDCCH monitoring complexity of the terminal may be minimized. However, it may take a long time for retransmission for some SPS resources. To reduce the SPS retransmission time delay, the search space set(s) described above may be arranged in multiple temporal locations (e.g., multiple slots, multiple symbol sets). A plurality of PDCCH monitoring occasions belonging to the same search space set may be mapped to the plurality of temporal locations. Alternatively, different search space sets may be mapped to the plurality of temporal locations. In an exemplary embodiment, search space sets (or PDCCH monitoring occasions corresponding to the search space sets) may be mapped between the SPS resources in the time domain. Alternatively, the search space sets may overlap in time with the SPS resource(s). In this case, the above-descried method of determining time resources of the search space sets based on the reference time may not operate. Alternatively, the method of determining the time resources of the search space sets may be inefficient. As another method, the time resource to which the search space set for SPS retransmission is mapped may be determined regardless of the location of the SPS resource. For example, the time resource to which the search space set for SPS retransmission is mapped may be determined by a resource periodicity and a time offset (e.g., slot offset and/or symbol offset) based on a specific radio frame (or radio frame boundary).

According to the above-described method, the terminal may perform a PDCCH monitoring operation after a predetermined time (e.g., the time offset) elapses after performing an SPS PDSCH reception (or monitoring) operation, and may receive DCI for scheduling a retransmission PDSCH for the SPS PDSCH. The PDCCH monitoring resource may be valid regardless of whether the SPS resource is included in the active time. The terminal may perform the PDCCH monitoring operation in the PDCCH monitoring resource regardless of whether the associated SPS resource is included in the active time. The PDCCH monitoring resource may be valid regardless of whether the PDCCH monitoring resource is included in the active time. The terminal may perform the PDCCH monitoring operation in the PDCCH monitoring resource regardless of whether the PDCCH monitoring resource is included in the active time.

As another method, the PDCCH monitoring operation in the PDCCH monitoring resource may be performed when a predetermined condition is satisfied. For example, when the PDCCH monitoring resource is included in a time outside an active time, the terminal may perform the PDCCH monitoring operation in the PDCCH monitoring resource. When the PDCCH monitoring resource is included in an active time, the terminal may not perform the PDCCH monitoring operation in the PDCCH monitoring resource. In the latter case, the terminal may perform a PDCCH monitoring operation in search space set(s) configured to be monitored in an active time, and may receive DCI scheduling retransmission for SPS transmission without the PDCCH monitoring resource configured by (Method 100). When the PDCCH monitoring resource includes a plurality of search space sets or a plurality of PDCCH monitoring occasions, whether the PDCCH monitoring resource is included in an active time or a time outside the active time may be determined for each search space set or PDCCH monitoring occasion. The terminal may monitor some or all search space set(s) or some or all PDCCH monitoring occasion(s) included in the period outside the active time.

The number of PDCCH candidates included in the PDCCH monitoring resource during a reference time (e.g., every slot) may not exceed a reference value. The reference value may be predefined in the technical specification. The reference value may be applied to each reference time (e.g., every slot) outside the DRX active time.

The PDCCH monitoring resource for SPS PDSCH retransmission may not be associated with an SPS resource and may be configured in the terminal independently of the SPS configuration. The PDCCH monitoring resource (e.g., search space set(s)) may be distinguished from the search space set(s) monitored by the terminal during an active time, and may be configured to the terminal separately from the search space set(s) monitored by the terminal during an active time. When a plurality of DRX configurations are configured in the terminal, the search space set(s) monitored by the terminal in an active time may be configured for each DRX configuration. In this case, the PDCCH monitoring resource for the SPS PDSCH retransmission may not have an inclusion relationship (or a subordination relationship) with any DRX configuration. The PDCCH monitoring resource (e.g., search space set(s)) may be associated with a separate CORESET (e.g., a CORESET configured separately for the above-described purpose only). For example, the search space set(s) may be associated with one CORESET, and the CORESET may not be associated with other search space set(s) (e.g., search space set(s) monitored in an active time, search space set(s) monitored for wake-up signal (e.g., DCI format 2_6) reception).

The search space set configured for SPS PDSCH retransmission may not be included in any search space set group (SSSG). That is, the search space set may be monitored regardless of SSSG switching operations of the terminal. The terminal may monitor the search space set configured for SPS PDSCH retransmission together with an SSSG indicated by the base station. When a sum of the number of PDCCH candidates belonging to the search space sets configured for SPS PDSCH retransmission and the number of PDCCH candidates belonging to the SSSG during a reference time (e.g., in a certain slot) exceeds a reference value, the search space sets for SPS PDSCH retransmission may be mapped with a lower priority (or higher priority) than a search space set belonging to the SSSG.

When the PDCCH monitoring resource for SPS PDSCH retransmission is mapped to an uplink symbol or the like, the PDCCH monitoring resource may not be valid and the terminal may not be able to receive scheduling information of SPS retransmission. As a method for solving the above-described problem, the PDCCH monitoring resource for SPS PDSCH retransmission may be configured in a plurality of carriers or a plurality of serving cells. The plurality of carriers may or may not include a carrier in which SPS retransmission is performed. For example, the terminal may receive configuration information of a plurality of carriers (or bandwidth parts corresponding to the plurality of carriers) in which the search space sets for SPS retransmission are configured, and the terminal may monitor the above-described search space sets all or simultaneously in the plurality of carriers. Alternatively, the terminal may select one of the plurality of carriers and monitor the above-described search space sets in the selected carrier. That is, the carrier for which the terminal monitors the search space set for SPS retransmission may be switched. When a PDCCH monitoring resource configured in a first carrier in a first time interval is not valid, the terminal may monitor a PDCCH monitoring resource configured in a second carrier in a time interval corresponding to the first time interval. The first carrier may be a default or primary carrier, and the second carrier may be a supplementary or secondary carrier.

As another method, when the PDCCH monitoring resource configured for SPS PDSCH retransmission in the first time interval is not valid, the terminal may monitor the PDCCH monitoring resource (e.g., PDCCH monitoring resource configured in the first time interval) or a PDCCH monitoring resource corresponding to the PDCCH monitoring resource (e.g., PDCCH monitoring resources configured in the first time interval) in a second time interval other than the first time interval. The second time interval may be a time interval appearing after the first time interval. For example, each of the first time interval and the second time interval may be a slot or a set of slots, and the terminal may determine a temporal distance between a slot (or set of slots) corresponding to the second time interval and a slot (or set of slots) corresponding to the first time interval based on signaling from the base station. Information on a location, configuration, PDCCH candidates, and/or the like of the PDCCH monitoring resource in the second time interval may be configured by the base station to the terminal.

[SPS Resource and CG Resource Configuration]

A configuration unit of an SPS periodicity or CG periodicity (hereinafter collectively referred to as ‘SPS periodicity’) may be a millisecond or subframe. For example, the SPS periodicity may be set to a multiple of 10 ms or a multiple of 32 ms. Alternatively, a configuration unit of an SPS periodicity may be a slot or symbol. For example, the SPS periodicity may be set to N1 slot(s) (or duration corresponding to N1 slot(s)). 2^{S1} slot(s) may be arranged within 1 ms, and a duration of one slot may be (½^{S1}) ms. S1 may be an integer. For another example, the SPS periodicity may be set to N2 symbol(s) (or duration corresponding to N2 symbol(s)). One slot may consist of S2 symbols, and N2 may be a divisor or a multiple of S2. S2 may be an integer. Meanwhile, a scan rate of a video content constituting an XR service may be defined as ‘frame per second (fps)’. For example, video traffic having a scan rate of 120 fps may periodically occur every 1/120 second (=8.33 ms). Therefore, according to the above-described method, it may be difficult to set the SPS periodicity to match the XR traffic periodicity.

As a method for solving the above-described problem, the SPS configuration and the CG configuration may be configured based on a plurality of periodicities. For convenience of description, a method for SPS configuration and operations related to the SPS configuration will be mainly described below, but the proposed method may be equally or similarly applied to CG configuration and operations related to the CG configuration. In exemplary embodiments, the SPS configuration, SPS configuration information, SPS period, SPS periodicity, PDSCH, downlink traffic, reception operation, and the like may respectively correspond to CG configuration, CG configuration information, CG period, CG periodicity, PUSCH, uplink traffic, transmission operation, and the like.

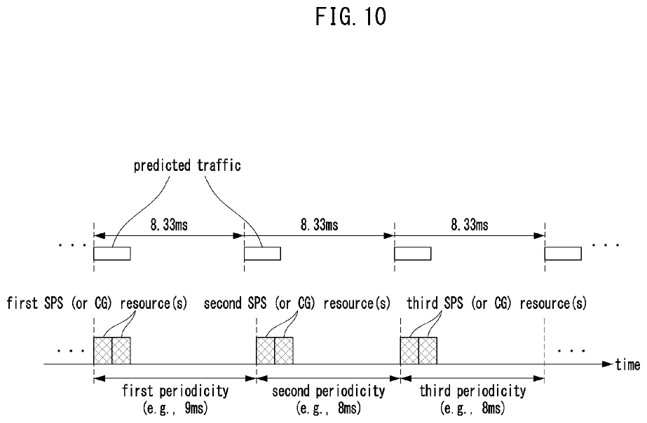

FIG. 10 is a conceptual diagram illustrating a first exemplary embodiment of an SPS configuration method based on a plurality of periodicities.

Referring to FIG. 10, the terminal may receive SPS configuration information from the base station for periodic reception of PDSCHs. SPS resources may be configured based on a plurality of periodicities (e.g., a first periodicity, a second periodicity, and a third periodicity). The SPS resources may be arranged for each period corresponding to each periodicity. For example, first SPS resource(s) may be arranged in a first period corresponding to the first periodicity, second SPS resource(s) may be arranged in a second period corresponding to the second periodicity, and third SPS resource(s) may be arranged in a third period corresponding to the third periodicity. The plurality of periodicities (or periods corresponding to the plurality of periodicities) may appear repeatedly in time according to the above-described order, and the SPS resources may also appear repeatedly in time in the order according to the periodicities (or periods). For example, the first periodicity, the second periodicity, and the third periodicity may be 9 ms, 8 ms, and 8 ms, respectively, and the first period, the second period, and the third period (or, the first SPS resource, the second SPS resource, and the third SPS resource respectively corresponding to the first period, the second period, and the third period) may appear repeatedly every 25 ms.

For example, when a periodicity of downlink traffic to be transmitted is 8.33 ms, each SPS periodicity does not completely match 8.33 ms, but a sum of the three SPS periodicities may match 3 periods (i.e., 25 ms) of the traffic. Accordingly, an arrival time of the traffic may be aligned with the SPS resources in units of 3 periods (i.e., 25 ms), and the traffic may be transmitted periodically in the SPS resources without increasing a latency.

The SPS resources corresponding to different periodicities may be allocated by time offsets and/or frequency offsets within the respective SPS periods corresponding to the respective SPS resources.

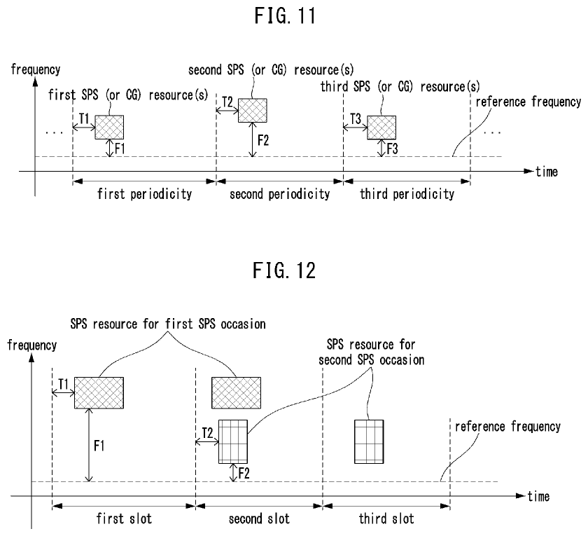

FIG. 11 is a conceptual diagram illustrating a second exemplary embodiment of an SPS configuration method based on a plurality of periodicities.

Referring to FIG. 11, the terminal may receive configuration information of an SPS resource based on a plurality of periodicities from the base station as in the first exemplary embodiment of FIG. 10. In the SPS periods corresponding to the first periodicity, the second periodicity, and the third periodicity, the first SPS resource, the second SPS resource, and the third SPS resource may be respectively arranged. Each SPS resource may be configured by a time offset and/or a frequency offset within each SPS period corresponding to each SPS resource.

For example, a time resource of each SPS resource may be expressed by a time offset (e.g., Ti, i=1,2,3) from a start time of the corresponding SPS period, and the time offset may mean a slot offset and/or symbol offset. A frequency resource of each SPS resource may be expressed by a frequency offset (e.g., Fi, i=1,2,3) from a reference frequency (e.g., a start resource block (RB) or start subcarrier of a bandwidth part or carrier, or a start RB or start subcarrier of the CORESET #0), and the frequency offset may mean an RB offset and/or subcarrier offset. When a plurality of SPS resources are configured within each SPS period, the above-described method may be applied to all SPS resources within each period. Alternatively, the above-described method may be applied to the first-positioned SPS resource in each period, and time resources and frequency resources of SPS resource(s) after the first-positioned SPS resource may be determined based on a time resource and a frequency resource of the first-positioned SPS resource, respectively.

In general, time offsets and/or frequency offsets of SPS resources corresponding to different periodicities may have different values. For example, there may be no association relationship between a configuration value of T1 and a configuration value of T2, and T1 and T2 may be set independently of each other. There may be no association relationship between a configuration value of F1 and a configuration value of F2, and T1 and T2 may be set independently of each other. According to the above-described method, flexibility of resource allocation may be increased, and the plurality of SPS periodicities may be used to transmit traffic or TBs having different sizes. On the other hand, the same traffic or traffic having a high correlation may be transmitted in the plurality of SPS periods. In this case, an association relationship may exist between time offsets and/or frequency offsets of the SPS resources corresponding to the different periodicities. For example, the time offset T2 of the second SPS resource may be determined by the time offset T1 of the first SPS resource. The frequency offset F2 of the second SPS resource may be determined by the frequency offset F1 of the first SPS resource. According to an exemplary embodiment, T2 may be equal to T1. According to an exemplary embodiment, F2 may be equal to F1. According to the above-described method, the amount of information on the locations of the SPS resources, which is transmitted to the terminal, may be reduced, and the signaling overhead may be reduced.

Additionally or alternatively, durations (e.g., the number of symbols to which an SPS PDSCH is allocated) of SPS resources corresponding to different periodicities and/or the size of the frequency resource (e.g., the number of RBs to which an SPS PDSCH is allocated) of the SPS resources corresponding to different periodicities may have different values. For example, the base station may independently determine the duration of the first SPS resource and the duration of the second SPS resource, and inform the terminal of the determined durations. In addition, the base station may independently determine the number of RBs of the first SPS resource and the number of RBs of the second SPS resource, and inform the terminal of the determined numbers of RBs. According to the method described above, flexibility of allocation of SPS resources may be increased. The above-described method may be useful in a TDD system in which a different configuration of transmission periods (e.g., downlink period, uplink period, and flexible period) is applied for each SPS period. Alternatively, an association relationship may exist between frequency resources and/or durations of SPS resources corresponding to different periodicities. For example, the duration of the second SPS resource may be the same as the duration of the first SPS resource. A frequency region (e.g., number of RBs, frequency location) of the second SPS resource may be the same as a frequency region (e.g., number of RBs, frequency location) of the first SPS resource.

When the durations and/or frequency resources of the first SPS resource and the second SPS resource are different from each other, the sizes (e.g., number of REs) of the first SPS resource and the second SPS resource may be different from each other. Meanwhile, transport block(s) (TB(s)) of the same size may be transmitted in SPS resources corresponding to different periodicities. For example, a TB having a first transport block size (TBS) may be selectively transmitted in one of the first SPS resource and the second SPS resource. For another example, a TB with a first TBS may be transmitted in the first SPS resource, and retransmission of the TB with the first TBS may be performed in the second SPS resource. In this case, the terminal may assume the same TBS for a PDSCH received in the first SPS resource and a PDSCH received in the second SPS resource.

As a method for guaranteeing the same TBS for the PDSCHs, the base station may explicitly configure a TBS for the SPS resource(s) in the terminal. For example, one TBS may be configured for one SPS configuration, and the one TBS may be applied to all SPS resources according to the SPS configuration. In the case of an SPS configuration by a plurality of periodicities, the terminal may assume the same TBS for PDSCH reception in SPS resources corresponding to the different periodicities. The base station may transmit SPS configuration information including information on the TBS to the terminal. In a method different from the above-described explicit configuration, in order to ensure that the same TBS is applied to a plurality of SPS resources, the base station may appropriately allocate the plurality of SPS resources and determine the size of the SPS resources appropriately. For example, the plurality of SPS resources may be allocated by the base station such that the number of REs of each of the plurality of SPS resources (or a value obtained by performing a certain operation on the number of REs of each of the plurality of SPS resources) is the same. The terminal may assume the same TBS for PDSCH reception in the plurality of SPS resources without receiving explicit configuration information for the TBS.

As another method, the base station may configure the plurality of SPS resources (e.g., SPS resources corresponding to different periodicities) such that the durations (e.g., number of symbols) and frequency bandwidths (e.g., number of RBs) of the plurality of SPS resources are the same. As a result, the sizes of the plurality of SPS resources may be the same or sufficiently similar, and TBSs assumed by the terminal for the plurality of SPS resources may be the same.

As yet another method, the TBS may be determined based on one SPS resource among the plurality of SPS resources (e.g., SPS resources corresponding to different periodicities), and the determined TBS may be equally applied to other remaining SPS resource(s). For example, the one SPS resource may be an SPS resource corresponding to a specific SPS periodicity (e.g., a first-numbered periodicity or the first periodicity in the above-described exemplary embodiment) or a specific SPS period (e.g., an SPS period appearing in the earliest order or the first period in the above-described exemplary embodiment). Alternatively, the one SPS resource (or a periodicity or period corresponding to the one SPS resource) may be configured in the terminal by the base station.

In addition to the above-described information, resource allocation information or scheduling information necessary for the terminal to perform SPS PDSCH reception may be commonly applied to the SPS resources corresponding to the different periodicities. For example, the terminal may apply at least one of the number of SPS resources in each SPS period, the number of repetitions of PDSCH transmissions, MCS, RV, RV pattern, overhead value assumed for TBS calculation, PDSCH mapping type, DM-RS type, DM-RS antenna port(s), or number of transmission layers commonly to the plurality of SPS resources (e.g., SPS resources corresponding to different periodicities), and based on the assumption, the terminal may perform a PDSCH reception operation in the plurality of SPS resources. Alternatively, the base station may configure at least one of the information listed above in the terminal for each SPS resource (e.g., each SPS resource corresponding to each periodicity), and the terminal may identify the information configured by the base station.

Meanwhile, an SPS PDSCH may be repeatedly transmitted. A plurality of PDSCHs (or a plurality of PDSCH instances) for the same TB (or TB(s) in case of multi-layer transmission) may be transmitted in a plurality of SPS resources. In this case, the plurality of SPS resources constituting repeated transmission may belong to the same SPS period. According to the method described above, the SPS resources constituting the repeated PDSCH transmission may belong to the same SPS period according the same periodicity. Alternatively, a plurality of SPS resources may be arranged in a plurality of SPS periods, and the repeated PDSCH transmission may be performed in the plurality of SPS resources. For example, in the above-described exemplary embodiment, PDSCHs (or PDSCH instances) for the same TB may be transmitted through the first SPS resource and the second SPS resource. In this case, the above-described method may be used as a method for the terminal to assume the same TBS for the plurality of SPS resources.

The combined SPS resource periodicity obtained by the above-described method may be configured to match or be similar to an integer multiple of the periodicity of traffic (e.g., 8.33 ms). However, if the combined SPS resource periodicity does not match a repetition periodicity of a slot format, characteristics of symbol(s) to which the SPS resources are mapped (e.g., transmission direction of the symbol(s), whether an SS/PBCH block, PRACH, etc. is mapped to the symbol(s)) may be different for each SPS period, and the SPS resources may not be valid in some SPS periods. Accordingly, SPS PDSCH transmission performance may be deteriorated in an SPS period including an invalid SPS resource.

As a method for solving the above-described problem, a slot format may be configured based on a plurality of periodicities. For example, a slot format may be configured for a first period, a second period, and a third period formed based on a first periodicity, a second periodicity, and a third periodicity, respectively. Information on transmission directions of slots and symbols constituting each period may be independently configured to the terminal for each period. The plurality of periods may be consecutive in time, and configuration of the slot format may be repeatedly applied for each combined period obtained by combining the plurality of periods. According to an exemplary embodiment, the combined period (or periodicity) of the slot format may coincide with a combined period (or periodicity) of the SPS resources. In addition, individual periods (or periodicities) configuring the combined period of the slot format may coincide with individual periods (or periodicities) configuring the combined period of the SPS resources. According to the above-described method, the format of the slot to which the SPS resources are mapped may be the same in all SPS periods.

Alternatively, when it is determined that a certain SPS resource is invalid in a certain SPS period, the terminal may skip an SPS PDSCH reception operation in the invalid SPS resource. When it is determined that the certain SPS resource is invalid in a first time interval, the terminal may shift the SPS resource from the first time interval to a second time interval. That is, the terminal may map the SPS resource to the second time interval. The terminal may perform an SPS PDSCH reception operation in the SPS resource (e.g., the shifted SPS resource) within the second time interval. The second time interval may be a time interval appearing after the first time interval. For example, the first time interval and the second time interval may each be a slot or a slot set, and the terminal may determine a temporal distance between a slot (or slot set) corresponding to the second time interval and a slot (or slot set) corresponding to the first time interval based on signaling from the base station. The location, configuration, and corresponding scheduling information of the SPS resource shifted and mapped to the second time interval may be configured by the base station to the terminal.

[Dynamic Indication of SPS Resource]

In addition to the traffic characteristics described above, an error may exist in a time required for sensing and processing real-time video information. Therefore, a jitter, which is a random time error, may exist in an arrival time (or occurrence time) of the XR traffic. Therefore, the XR traffic may arrive a little earlier or a little later than an average arrival time in each period. It may be difficult for a communication node (e.g., base station or terminal) to predict the exact arrival time of traffic. In addition, the size of XR traffic may be changed for each period according to a compression rate of the video information.

As described above, when a jitter exists in the traffic, even if SPS resources are configured according to the average arrival time of the traffic, actually occurring traffic may arrive earlier or later than the SPS resource. If a deviation of the arrival time of the traffic is large, the traffic may be difficult to transmit through the corresponding SPS resource, and transmission of the traffic having a low-latency QoS may fail.

As a method for solving the above-described problem, a method of dynamically indicating an SPS occasion (e.g., SPS resource location, SPS PDSCH scheduling information, etc.) to the terminal may be used. Here, the SPS occasion may mean a set of SPS resources having a periodicity. According to an exemplary embodiment for this purpose, one ‘SPS configuration’ may include configuration information on a plurality of SPS occasions, a plurality of candidate SPS occasions, or a plurality of candidate SPS configurations. Each SPS occasion may include information on an SPS resource set and/or information on SPS PDSCH scheduling. A message or parameter corresponding to the information may be configured to a different value (e.g., independently) for each SPS occasion. For example, the terminal may receive configuration information of a first SPS occasion and a second SPS occasion for a certain SPS configuration. The first SPS occasion may include information on a first time resource and/or a first frequency resource related to SPS resource(s), and the second SPS occasion may include information on a second time resource and/or a second frequency related to SPS resource(s). In addition, the number of SPS resources for each SPS period, the number of repetitions of PDSCH transmissions, MCS, RV, RV pattern, PDSCH mapping type, and/or DM-RS mapping information may be configured individually for the first SPS occasion and the second SPS occasion.

FIG. 12 is a conceptual diagram illustrating a first exemplary embodiment of a method for dynamically indicating an SPS occasion.

Referring to FIG. 12, the terminal may receive information on an SPS configuration from the base station. The SPS configuration may include information on a first SPS occasion and a second SPS occasion. In this case, according to the above-described method, the first SPS occasion and the second SPS occasion may include different SPS resource information. According to the first SPS occasion, SPS resources may be configured in a first slot and a second slot. According to the second SPS occasion, SPS resources may be configured in the second slot and a third slot. An in-slot time resource (e.g., time offset T1 and/or duration) of the SPS resource by the first SPS occasion and an in-slot time resource (e.g., time offset T2 and/or duration) of the SPS resource by the second SPS occasion may be configured differently. A frequency resource (e.g., frequency offset F1 from a reference frequency and/or bandwidth) of the SPS resource by the first SPS occasion and a frequency resource (e.g., frequency offset F2 from a reference frequency and/or bandwidth) of the SPS resource by the second SPS occasion may be configured differently.

Meanwhile, the same SPS periodicity may be applied to the plurality of SPS occasions described above. One SPS periodicity may be configured for each SPS configuration, and the one SPS periodicity may be commonly applied to the plurality of SPS occasions included in the SPS configuration. SPS periods formed according to the one SPS periodicity may be commonly applied to the plurality of SPS occasions. A start time and length of each period of the first SPS occasion may be the same as a start time and length of each period of the second SPS occasion. In the above-described exemplary embodiment, the two SPS resources corresponding to the first SPS occasion and the two SPS resources corresponding to the second SPS occasion may belong to the same SPS period (e.g., common period having the same start time and length). Alternatively, the start time of each SPS period for the first SPS occasion may be configured to be different from the start time of each SPS period for the second SPS occasion. In this case, a time offset (e.g., slot(s), symbol(s), subframe(s)) of the SPS period for each SPS occasion may be configured to the terminal

The terminal may receive a downlink signal from the base station, and based on the received downlink signal, one SPS occasion among the configured plurality of SPS occasions may be indicated to the terminal. The terminal may determine an SPS resource based on the indicated SPS occasion, and may perform an SPS PDSCH reception operation in the SPS resource. The downlink signal indicating the SPS occasion (hereinafter, referred to as ‘indication signal’) may be a PDCCH. The PDCCH may include DCI (or DCI format), and the information indicating the SPS occasion may be included in the DCI (or DCI format). For example, the DCI may be group common DCI. For example, the DCI format may be a DCI format 2_6. The indication signal may be a wake-up signal (or at least a signal used to indicate a DRX operation of the terminal). For another example, the DCI may be a UE-specific DCI, and the DCI may be DCI (e.g., DCI formats 0_0, 0_1, 1_0, 1_1, etc.) including scheduling information of a data channel (e.g., PDSCH, PUSCH). For another example, the indication signal may be a reference signal (e.g., CSI-RS, DM-RS) or a synchronization signal (e.g., SSS, PSS, etc.). The indication signal may be a signal configured with a sequence generated by a physical layer.

The indication signal may be associated with the SPS configuration. Configuration information of the indication signal may be associated with SPS configuration information. For example, the indication signal may be a PDCCH, and configuration information required for the terminal to monitor the PDCCH (e.g., configuration information of search space set(s), CORESET(s), PDCCH monitoring occasion(s), etc.) may be configured in the terminal so as to be associated with the SPS configuration.

A resource location of the indication signal may be determined based on a location of SPS resource(s) allocated by the associated SPS configuration. For example, the indication signal may be a PDCCH, and time resource(s) of search space set(s) (or PDCCH monitoring occasion(s) corresponding to the search space set(s)) to be monitored by the terminal may be determined based on the associated SPS resource(s).

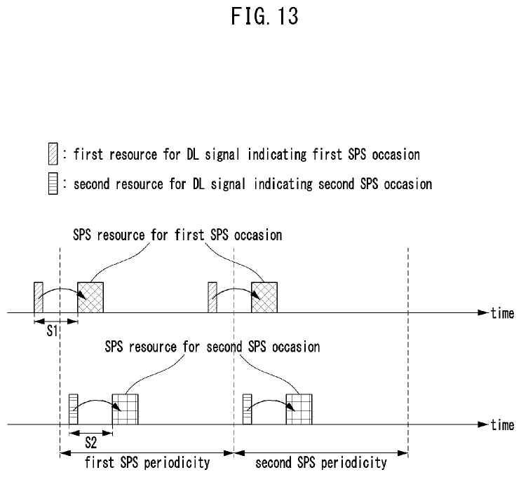

FIG. 13 is a conceptual diagram illustrating a second exemplary embodiment of a method for dynamically indicating an SPS occasion.

Referring to FIG. 13, the terminal may receive configuration information on an SPS configuration from the base station. The SPS configuration may include information on a first SPS occasion and a second SPS occasion, and the first SPS occasion and the second SPS location may include information for allocating different SPS resources within the same period. For example, SPS resources by the first SPS occasion may precede SPS resources by the second SPS occasion in the time domain.

Through the above-described method, the base station may transmit a downlink signal indicating an SPS occasion to the terminal. A plurality of resources for transmission of the indication signal may be configured in the terminal so as to be associated with each SPS occasion. The terminal may receive configuration information of a first resource for receiving (or monitoring) a signal indicating the first SPS occasion from the base station, and may receive (or monitor) configuration information of a second resource for receiving (or monitoring) a signal indicating the second SPS occasion from the base station. When receiving the indication signal in the first resource, the terminal may determine (or activate) an SPS resource based on the first SPS occasion associated with the first resource, and perform an SPS PDSCH reception operation in the determined (or activated) resource based on the first SPS occasion. When receiving the indication signal in the second resource, the terminal may determine (or activate) an SPS resource based on the second SPS occasion associated with the second resource, and perform an SPS PDSCH reception operation in the determined (or activated) resource based on the second SPS occasion. The SPS occasion may be implicitly indicated to the terminal based on the resource in which the indication signal is received. The terminal may identify the implicitly indicated SPS occasion.

According to the above-described exemplary embodiment, a plurality of resources for transmission of the indication signal may be respectively determined based on SPS resources allocated by the associated SPS occasions. The first resource may be determined based on an SPS resource allocated by the first SPS occasion. For example, a time resource (e.g., slot, symbol) of the first resource may be determined as a time ahead by a time offset S1 from a time resource (e.g., slot, symbol) of the SPS resource allocated by the first SPS occasion. The second resource may be determined based on an SPS resource allocated by the second SPS occasion. For example, a time resource (e.g., slot, symbol) of the second resource may be determined as a time ahead by a time offset S2 from a time resource (e.g., slot, symbol) of the SPS resource allocated by the second SPS occasion. Each of S1 and S2 may mean a predetermined number of slots (or a duration corresponding to a predetermined number of slots) or a predetermined number of symbols (or a duration corresponding to a predetermined number of symbols). S1 and S2 may be configured by the base station to the terminal, respectively. According to an exemplary embodiment, S1 may be equal to S2.

As another method, a plurality of resources for transmission of the indication signal may be determined by time offsets from a common reference resource. For example, the first resource may be determined by a first time offset from the common reference resource, and the second resource may be determined by a second time offset from the common reference resource. Similarly, each of the time offsets may mean a predetermined number of slots (or a duration corresponding to a predetermined number of slots) or a predetermined number of symbols (or a duration corresponding to a predetermined number of symbols). The base station may configure the time offsets to the terminal. The common reference resource may be an SPS resource formed based on one SPS occasion (e.g., an SPS occasion having the lowest index, a default SPS location, or the like). Alternatively, the common reference resource may mean a time within an SPS period (e.g., a start time of the SPS period, the first slot or first symbol of the SPS period, or the like).

According to the above-described method, the periodicity of the resource of the indication signal may coincide with the SPS periodicity. For example, the terminal may monitor a PDCCH indicating an SPS resource and/or SPS scheduling information in search space set(s) (or PDCCH monitoring occasion(s) corresponding to search space set(s)). The search space set(s) (or PDCCH monitoring occasion(s) corresponding to the search space set(s)) may be periodically monitored based on an SPS periodicity according to an SPS configuration associated with the search space set(s).

As yet another method, a plurality of resources for transmission of the indication signal may be configured to the terminal regardless of an SPS configuration or SPS resources. For example, the indication signal may be a PDCCH, and search space set(s) for monitoring the PDCCH may be configured in the terminal independently of an SPS configuration. For example, a resource (e.g., slot(s) and/or symbol(s) to which the search space set(s) (or PDCCH monitoring occasion(s) corresponding to the search space set(s)) is mapped) may appear periodically and repeatedly, and a time offset (e.g., slot(s), symbol(s)) from a start time of each period to the resource may be configured to the terminal. A periodicity for forming the periods may be configured to the terminal, and the periods may be arranged consecutively from a reference time (e.g., a specific radio frame, a start time of a radio frame corresponding to a system frame number (SFN) of 0).

In this case, an SPS resource may be determined based on the resource for transmission of the indication signal. For example, a time offset from the transmission resource of the indication signal (e.g., the resource to which the search space set(s) are mapped) to the SPS resource may be included in information on the SPS occasion. For example, the first SPS occasion may include information on a time offset from the first resource to the SPS resource. When receiving the indication signal in the first resource, the terminal may determine a location of the SPS resource according to the first SPS occasion based on the information on the time offset, and may perform an SPS PDSCH reception operation in the SPS resource. The second SPS location may include information on a time offset from the second resource to the SPS resource. When receiving the indication signal in the second resource, the terminal may determine a location of the SPS resource according to the second SPS occasion based on the information on the time offset, and may perform an SPS PDSCH reception operation in the SPS resource. For example, the time offset may include information indicating a slot offset between a slot to which the first resource is mapped and a slot to which the SPS resource associated with the first resource is mapped, and information (e.g., symbol index) on a location of a symbol to which the SPS resource is mapped within the slot to which the SPS resource is mapped. For another example, the time offset may include a symbol offset between a symbol (e.g., the last symbol) to which the first resource is mapped and a symbol (e.g., the first symbol) to which the SPS resource associated with the first resource is mapped.

According to the method described above, the period (or periodicity) of the resource of the indication signal may be configured to the terminal separately from the SPS period (or periodicity).

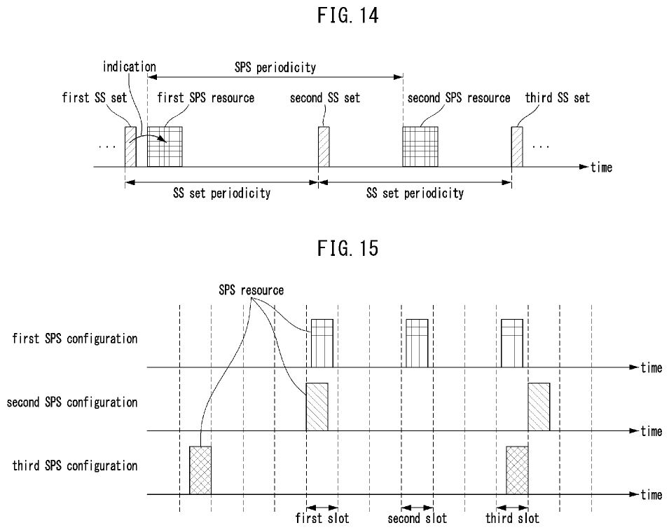

FIG. 14 is a conceptual diagram illustrating a third exemplary embodiment of a method for dynamically indicating an SPS occasion.

Referring to FIG. 14, the terminal may monitor a PDCCH indicating an SPS resource and/or SPS scheduling information in search space set(s) (or PDCCH monitoring occasion(s) corresponding to search space set(s)), and a resource periodicity (i.e., monitoring periodicity) of the search space set(s) (or PDCCH monitoring occasion(s) corresponding to the search space set(s)) may be configured to the terminal separately from the SPS periodicity. In this case, the terminal may perform a PDCCH monitoring operation based on the periodicity of the search space set (e.g., the periodicity of the search space set rather than the SPS periodicity), and perform an SPS PDSCH reception operation based on the SPS periodicity. For example, the terminal may receive DCI from a first search space set, and may perform an SPS PDSCH reception (or monitoring) operation in a first SPS resource indicated by the DCI. The terminal may determine a second SPS resource of the next SPS period based on the SPS periodicity (e.g., the SPS periodicity rather than the periodicity of the search space set), and perform an SPS PDSCH reception (or monitoring) operation in the second SPS resource. Alternatively, the second SPS resource of the next SPS period may be determined based on the periodicity of the search space set. SPS transmission may be performed periodically based on the resource periodicity of the indication signal.

Referring to FIG. 13, the transmission resource (e.g., the first resource) of the indication signal may be arranged in an SPS period (e.g., a previous SPS period) different from that of the associated SPS resource. The transmission resource (e.g., the second resource) of the indication signal may be arranged in the same SPS period together with the associated SPS resource. A plurality of resources for transmission of the indication signal may not overlap each other. On the other hand, overlapping of a plurality of resources for transmission of the indication signal may be allowed. The terminal may expect to receive the indication signal in one of the plurality of resources. Therefore, even when the plurality of resources overlap, the terminal may normally receive the indication signal. The transmission resource of the indication signal may overlap with the SPS resource. For example, the second resource may overlap with the SPS resource allocated by the first SPS occasion. Similarly, the terminal may expect that reception of the indication signal in the second resource and reception of an SPS PDSCH in the SPS resource allocated by the first SPS occasion do not occur simultaneously. Therefore, even when the transmission resource of the indication signal overlaps with the SPS resource, the terminal may normally perform an SPS PDSCH reception operation.

When the indication signal is a PDCCH, the transmission resource of the indication signal may mean search space set(s) (or CORESET(s), PDCCH monitoring occasion(s), and/or PDCCH candidate(s) corresponding to the search space set(s)). For example, the first resource may be a first search space set group, and the second resource may be a second search space set group. The terminal may determine a location of an SPS resource based on an SPS occasion associated with a search space set group in which a PDCCH indicating an SPS occasion is successfully received, and may perform an SPS PDSCH reception operation based on the SPS occasion in the determined SPS resource.

As another, the SPS occasion may be indicated to the terminal by a payload of the indication signal instead of the transmission resource of the indication signal. For example, information indicating one SPS occasion among a plurality of SPS occasions configured in the terminal may be included in a DCI payload, and DCI including the payload may be transmitted to the terminal through the PDCCH resource. For example, each of the SPS occasions configured in the terminal may be mapped to each codepoint of a specific field of the DCI. For example, the terminal may receive information on four SPS occasions from the base station for a certain SPS configuration. Each of the four SPS occasions may be indicated by code points ‘00’, ‘01’, ‘10,’ or ‘11’ constituting a 2-bit DCI field.

In the above-described exemplary embodiments, the SPS resource allocated by each SPS occasion may mean a plurality of SPS resources. In the above-described exemplary embodiments, the SPS resource may mean one SPS resource (e.g., the earliest SPS resource) among a plurality of SPS resources.

The indication signal may be transmitted within a DRX active time and/or outside a DRX active time according to the location of the associated SPS resource(s). When the indication signal is a PDCCH, the terminal may perform a monitoring operation of a search space set for receiving the PDCCH within an active time and/or outside an active time according to the location of the SPS resource(s) associated with the search space set. Even when the indication signal is a WUS (e.g., DCI format 2_6), the terminal may perform a monitoring operation and/or a reception operation for the WUS within an active time as well as outside an active time.

Configuration of the plurality of SPS occasions may be distinguished from configuration of a plurality of SPS configurations. For example, traffic may be composed of a plurality of sub-traffic having independent periodicities, and the base station may configure a plurality of SPS configurations to transmit the plurality of sub-traffic to the terminal. When a plurality of SPS configurations are configured in the terminal, a plurality of SPS occasions may be configured for each SPS configuration. For example, the terminal may receive, from the base station, information on a first SPS configuration and a second SPS configuration for SPS PDSCH reception. The first SPS configuration may include a first SPS occasion and a second SPS occasion, and the second SPS configuration may include a third SPS occasion, a fourth SPS occasion, and a fifth SPS occasion. According to the above-described method, SPS occasions belonging to the same SPS configuration may share the same SPS periodicity. On the other hand, each of the plurality of SPS configurations may have an independent SPS periodicity. Meanwhile, a certain SPS configuration may include one SPS occasion. In this case, the operation of indicating an SPS occasion based on a downlink signal may be omitted.

According to another exemplary embodiment, one SPS configuration may include information on a plurality of candidate parameters. The candidate parameter may correspond to the aforementioned SPS occasion. For example, one SPS configuration may include configuration information on a plurality of candidate SPS resources, and configuration information of each candidate SPS resource may include information on a time-frequency resource of the SPS resource. SPS resource mapping information included in different candidate SPS resources may be independent of each other. That is, the SPS resource mapping information included in different candidate SPS resources may be identical to or different from each other. For another example, one SPS configuration may include configuration information on a plurality of MCSs, and each MCS configuration information may be associated with a different candidate SPS resource. As described above, the terminal may receive a downlink signal (e.g., DCI) from the base station, identify one candidate parameter (e.g., one candidate SPS resource) indicated by the received signal (e.g., DCI) among the plurality of candidate parameters (e.g., a plurality of candidate SPS resources), and perform an SPS PDSCH reception operation based on the indicated candidate parameter (e.g., candidate SPS resource).

According to the method described above, the terminal may identify the SPS resource and/or SPS scheduling information dynamically indicated by the signal received from the base station. Hereinafter, a range of resources, a time interval, and/or the like to which the indication of the SPS resource is applied will be described.

As a first method, the indicated SPS resource and/or SPS scheduling information may be valid for one time or one period. The terminal may apply the indicated SPS resource and/or SPS scheduling information to one SPS period or a resource period of one indication signal (e.g., a period of the search space set or the PDCCH monitoring occasion), determine one or more SPS resource(s) in the one period (or resource period of the one indication signal) based on the indicated SPS resource and/or SPS scheduling information, and perform a PDSCH reception (or monitoring) operation in the determined SPS resource(s). Referring again to FIG. 14, the terminal may configure the first SPS resource based on the DCI received in the first search space set, and may perform an SPS PDSCH reception operation in the first SPS resource according to the above-described method. In addition, the DCI may not indicate an SPS resource (i.e., the second SPS resource) of the next SPS period or the next search space set period, and the terminal may not perform an SPS PDSCH reception operation in the SPS resource (i.e., the second SPS resource). The base station may transmit an additional indication signal (e.g., DCI transmitted in the second search space set) to the terminal in order to transmit an SPS PDSCH to the terminal in the second SPS resource. When the above-described method is applied and the indication signal (e.g., PDCCH) is not received in the transmission resource (e.g., search space set) of the indication signal, the terminal may consider that an SPS PDSCH is not transmitted in the next period (e.g., the next SPS period or the next search space set period), and may not perform an SPS PDSCH reception operation.

As a second method, the indicated SPS resource and/or SPS scheduling information may be valid for a plurality of periods. The terminal may apply the indicated SPS resource and/or SPS scheduling information to a plurality of SPS periods or resource periods of a plurality of indication signals (e.g., a plurality of search space set periods), determine one or more SPS resource(s) in each of the plurality of periods (or resource periods of the plurality of indication signals) based on the determined SPS resource and/or SPS scheduling information, and perform a PDSCH reception (or monitoring) operation in the determined SPS resource(s). Referring again to FIG. 14, according to the above-described method, the terminal may configure a plurality of SPS resource (e.g., first SPS resource and second SPS resource) for the plurality of SPS periods or the plurality of search space set periods based on the DCI received in the first search space set, and perform an SPS PDSCH reception operation in the first SPS resource and the second SPS resource. The number of periods to which the indication is applied may be configured by the base station to the terminal.

In the above-described method, the indicated SPS resource and/or SPS scheduling information may be valid for all subsequent periods. The terminal may perform an SPS PDSCH reception operation in every period based on the indication until a new indication signal is received or the SPS resource according to the indication is deactivated.

According to the above-described method, the terminal may receive a plurality of indication signals indicating SPS resource(s) for the same SPS period (or the same resource period of the indication signal). For example, the terminal may receive first DCI from a first search space set and second DCI from a second search space set. The first DCI may include first indication information for a first SPS period, and the second DCI may include second indication information for the first SPS period. In this case, the first indication information and the second indication information may be the same. That is, the terminal may not expect to receive a plurality of DCIs indicating different SPS configurations for the same SPS period, and may expect the received plurality of DCIs to include the same SPS indication information. Alternatively, the first indication information and the second indication information may be different from each other. In this case, the terminal may apply one indication information to the SPS period and configure an SPS resource for SPS PDSCH reception. The one indication information may be indication information included in DCI received later among the first DCI and the second DCI (e.g., DCI received in a later search space set period, DCI having a later end symbol, or the like). That is, a previously indicated SPS configuration may be overridden by a later indicated SPS configuration for the same target (e.g., SPS resource of the same SPS period).

As a method different from the above-described method, the terminal may perform an SPS PDSCH reception operation for each of a plurality of SPS occasions belonging to the same SPS configuration. For example, the terminal may receive configuration information of a first SPS occasion and a second SPS occasion for a certain SPS configuration. Both the first SPS occasion and the second SPS occasion may be activated. The terminal may determine a first SPS resource and a second SPS resource based on configuration information of the first SPS occasion and the second SPS occasion, respectively, and perform a PDSCH reception operation in the first SPS resource and the second SPS resource.

Specifically, the terminal may monitor or blind-decode (or demodulate) a PDSCH in the first SPS resource and the second SPS resource. The terminal may receive a PDSCH for which blind-decoding (or demodulation) has been successfully performed, and may perform a subsequent operation corresponding to the received PDSCH. In this case, it may be allowed for the terminal to receive PDSCH in SPS resources corresponding to a plurality of SPS occasions. The SPS resources may not overlap each other. When the SPS resources overlap each other, the terminal may expect to successfully receive a PDSCH only in one SPS resource among the SPS resources. Alternatively, the terminal may expect to receive a PDSCH in an SPS resource corresponding to one (or at most one) SPS occasion for one SPS configuration. The above-described operation may be performed regardless of whether the SPS resources overlap. According to the above-described operation, when the terminal succeeds in receiving a PDSCH in the first SPS resource corresponding to the first SPS occasion, the terminal may skip a PDSCH reception operation (or monitoring operation) in the second SPS resource corresponding to the second SPS occasion. The above-described operation may be performed within each SPS period. Regarding different SPS periods, the terminal may successfully receive PDSCHs in SPS resources of different periods corresponding to different SPS occasions. Alternatively, the terminal may successfully receive PDSCHs in SPS resources of different periods corresponding to the same SPS occasion.

As described above, in order to transmit multi-flow traffic, the terminal may receive information on a plurality of SPS configuration. In this case, SPS resources according to different SPS configurations may be allocated to the same slot, and the terminal may receive a plurality of PDSCHs in a plurality of SPS resources of the slot. Meanwhile, an HARQ process ID of an SPS PDSCH may be determined by a slot index (or slot number). According to this, the same HARQ process ID may be assigned to PDSCHs transmitted in the same slot. The HARQ process IDs of the PDSCHs may collide. The collision of the HARQ process ID may be avoided by properly setting an offset of the HARQ process ID for each SPS configuration. However, the above-described method may be useful only when SPS resources by a plurality of SPS configurations overlap at a regular periodicity. Here, overlapping of a plurality of SPS resources may mean that the plurality of SPS resources belong to the same time interval. The overlapping of a plurality of SPS resources may not necessarily mean that the plurality of SPS resources are mapped to the same time resource (e.g., the same symbol(s)).

FIG. 15 is a conceptual diagram illustrating a first exemplary embodiment of an SPS resource configuration method for a plurality of SPS configurations.

Referring to FIG. 15, the terminal may receive information on a first SPS configuration, a second SPS configuration, and a third SPS configuration from the base station. Periodicities and slot offsets for resources of the SPS configurations may be different. For example, the periodicities of the first SPS configuration, the second SPS configuration, and the third SPS configuration may be 3 slots, 6 slots, and 10 slots, respectively. As a result, SPS resources allocated by the SPS configurations may overlap in a specific slot, and an overlapping time pattern may be irregular. For example, in the first slot, SPS resources according to the first SPS configuration and SPS resources according to the second SPS configuration may overlap. In the third slot, SPS resources according to the first SPS configuration and SPS resources according to the third SPS configuration may overlap. In the second slot, SPS resources according to the first SPS configuration may not overlap with other SPS resources. In this case, it may be difficult to avoid collision of HARQ process IDs between SPS resources in all slots in which SPS resources are arranged only by the method of assigning an HARQ process ID offset for each SPS configuration.

As a proposed method, the HARQ process ID of the SPS resource may be determined based on an index (or number) of the SPS configuration corresponding to the SPS resource and/or the number of SPS configurations configured in the terminal. HARQ process IDs of SPS resources overlapping in the same time interval (e.g., the same slot) may be distinguished by the indexes of the SPS configurations corresponding to the HARQ process IDs. In this case, the SPS configuration may mean an activated SPS configuration (e.g., activated by DCI). In an exemplary embodiment, the number of SPS configurations may mean the number of SPS configurations corresponding to SPS resources in which the terminal actually performs a PDSCH reception operation in each slot.

As another proposed method, the base station may dynamically assign an HARQ process ID of an SPS resource (e.g., PDSCH transmitted in the SPS resource), and may indicate the assigned HARQ process ID to the terminal. The indication of the HARQ process ID may be applied for each SPS period. For example, the HARQ process ID of each SPS resource may be included in a signal (e.g., DCI) dynamically indicating the above-described SPS configuration, and the signal may be transmitted to the terminal.

[Dynamic Indication of CG Resource]

In the case of uplink XR traffic, the terminal may receive configuration information of periodic CG-PUSCH resources from the base station, and may periodically transmit a CG-PUSCH to the base station in the CG-PUSCH resource. The uplink traffic (e.g., uplink XR traffic) may include a jitter, and the size of the uplink traffic may vary with time. The terminal may dynamically determine (or change) a location of the transmission resource of the CG-PUSCH according to an arrival time of the traffic (e.g., uplink traffic), and may dynamically determine (or change) the size or transmission parameters (e.g., MCS, TBS, number of transmission layers, and/or the like) of the CG-PUSCH according to the size of traffic.

For the above-described operation, the terminal may receive information of a plurality of CG occasions, a plurality of candidate CG occasions, or a plurality of candidate CG configurations for one CG configuration from the base station. Here, the CG occasion may mean a set of CG resources having a periodicity. Each CG occasion may include CG-PUSCH resource allocation information, CG-PUSCH scheduling information (or transmission parameters), and the like. A message or parameter corresponding to the information may be set to a different value for each CG occasion. That is, the message or parameter corresponding to the information may be independently configured for each CG occasion. For example, the terminal may receive information on a first CG occasion and a second CG occasion for a certain CG configuration. The first CG occasion may include information on a first time resource and a first frequency resource of a CG resource, and the second CG occasion may include information on a second time resource and a second frequency resource of a CG resource.

The first time resource and the second time resource may mean symbol(s) to which CG-PUSCH is mapped, and may be configured as the same symbol set or different symbol sets. The first frequency resource and the second frequency resource may mean RB(s) to which CG-PUSCH is mapped, and may be configured as the same RB set or different RB sets. In addition, the number of CG-PUSCH resources, the number of repetitions of CG-PUSCH transmission, MCS, RV, RV pattern, number of transmission layers, PUSCH mapping type, and/or DM-RS mapping information may be configured individually for the first CG occasion and the second CG occasion.

The terminal may select some CG occasion(s) among the plurality of CG occasions according to an arrival time and/or size of traffic, and may determine CG-PUSCH resource(s), CG-PUSCH transmission parameter(s), and/or the like based on the selected CG occasion(s). The terminal may transmit CG-PUSCH(s) to the base station in the determined CG-PUSCH resource(s) by applying the determined CG-PUSCH transmission parameter(s).

The CG configuration or CG occasion configured in the terminal may be dynamically activated or released (or deactivated). For example, the base station may instruct the terminal to activate a specific CG configuration or a specific CG occasion or to release a specific CG configuration or a specific CG occasion through DCI. When a plurality of CG configurations are configured in the terminal, each of the plurality of CG configurations may be activated or released by individual indication signaling. Alternatively, the plurality of CG configurations may be activated or released together by the same indication signaling. In addition, when one CG configuration includes a plurality of CG occasions, each of the plurality of CG occasions may be activated or released by individual indication signaling. Alternatively, the plurality of CG occasions may be activated or released together by the same indication signaling. Here, the indication signaling may mean a PDCCH, DCI, DCI format, or the like. For example, information indicating activation or release of CG resources may be transmitted to the terminal as being included in a DCI format (e.g., DCI format 0_0, 0_1, 0_2) including PUSCH scheduling information. The DCI format may include resource allocation information and scheduling information of a CG occasion or CG resource to be activated. The resource allocation information may include information on a time resource and a frequency resource of the CG occasion or CG resource, and the scheduling information may include information required for the terminal to transmit a PUSCH in the CG occasion or CG resource (e.g., the number of repetitions of CG PUSCH transmission, MCS, RV, RV pattern, number of transmission layers, PUSCH mapping type, DM-RS mapping information, and/or the like). Hereinafter, a specific method of activating or releasing a plurality of CG occasions based on DCI will be described.

For convenience of description, a method of activating or releasing CG occasions will be mainly described below, but the proposed method may be equally or similarly applied to activating and releasing SPS occasions. In exemplary embodiments, CG configuration, CG occasion, CG period, CG resource, CG-PUSCH, transmission operation, and the like may correspond to SPS configuration, SPS occasion, SPS period, SPS resource, SPS PDSCH, reception operation, and the like, respectively.

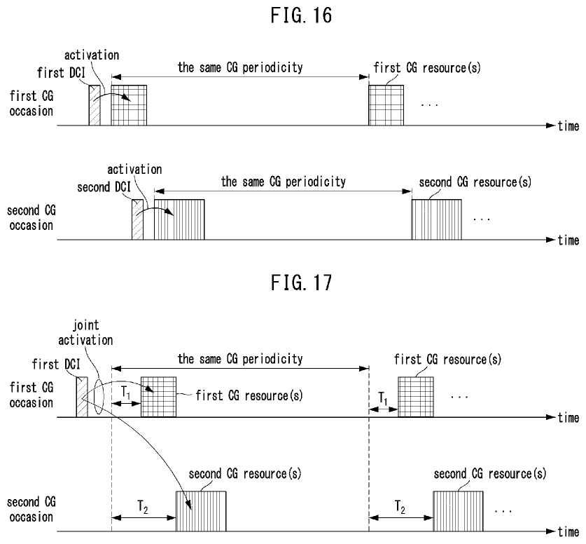

FIG. 16 is a conceptual diagram illustrating a first exemplary embodiment of a method of individually activating a plurality of CG occasions.

Referring to FIG. 16, a first CG occasion and a second CG occasion may be activated in the terminal. The first CG occasion and the second CG occasion may be included in the same CG configuration. According to a proposed method, the plurality of CG occasions may be activated based on individual signaling procedures. For example, information indicating activation of the first CG occasion and the second CG occasion may be respectively included in the first DCI and the second DCI, and transmitted to the terminal. The terminal may activate a corresponding CG occasion based on each indication information, and transmit a PUSCH in the activated CG occasion (e.g., CG PUSCH resource(s) belonging to the CG occasion).

In this case, a time at which each CG occasion is activated may be determined based on a time at which DCI including activation indication information is received. For example, the terminal may activate the corresponding CG occasion at a time (e.g., slot, subslot, symbol) after a predetermined time offset (e.g., slot offset, subslot offset, symbol offset) from a time (e.g., slot, subslot, symbol) at which the DCI is received. The time offset may be predefined in the technical specification. Alternatively, information on the time offset may be transmitted from the base station to the terminal. When DCIs are received at different times, CG occasions belonging to the same CG configuration may be activated at different times. In addition to the method described above, a time when each CG occasion is activated may be determined based on control information included in DCI including activation indication information. For example, the activation time (e.g., slot, subslot, symbol, subframe, etc.) of the CG occasion may be expressed by a time offset (e.g., slot offset, subslot offset, symbol offset, subframe offset, or the like) from a transmission time (e.g., slot, subslot, symbol, subframe) of the DCI. The base station may determine the activation time of the CG occasion by appropriately adjusting the transmission time of the DCI and the time offset. The DCI including the activation indication information of the CG occasion may include resource allocation information and scheduling information of the CG occasion to be activated or CG resource(s) belonging thereto.

The same CG periodicity (or period) may be applied to a plurality of CG occasions within one CG configuration. For example, information on the CG periodicity may be included in CG configuration information, and the CG periodicity may be applied to all CG occasions included in the CG configuration. Referring to FIG. 16, first CG resource(s) and second CG resource(s) may repeatedly appear based on the same CG periodicity. In this case, a start time of a CG period (or a boundary between CG periods) may be independently determined for each CG occasion. For example, a start time of a CG period corresponding to the first CG occasion may be determined based on the activation time of the first CG occasion, the reception time of the DCI indicating to activate the first CG occasion, location of CG resource(s) included in the first CG occasion, and/or the like. Alternatively, the start time of the CG period may not be separately defined. Alternatively, start times of CG periods for a plurality of CG occasions may coincide. The start time of the CG period may be determined based on an activation time of a reference CG occasion, a reception time of DCI indicating activation of the reference CG occasion, and a location of CG resource(s) included in the reference CG occasion. The reference CG occasion may be one CG occasion among the plurality of CG occasions. For example, the reference CG occasion may be determined based on an order in which the CG occasions are activated. The reference CG occasion may be a first activated CG occasion among the plurality of CG occasions. According to the above-described method, when reception of DCI indicating activation of the reference CG occasion fails, it may be difficult for the terminal to normally acquire the start time of the CG period. In order to solve the above-described problem, a CG occasion assigned a specific CG occasion index (e.g., index 0, an index configured by the base station) may be used as the reference CG occasion. Alternatively, the terminal may determine the start time of the CG period based on configuration information received from the base station (e.g., separate configuration information distinct from the activation indication information).

An index may be assigned to each CG occasion to distinguish CG occasions within one CG configuration. A method of assigning CG occasion indexes may be associated with a method of configuration and activating CG occasions. According to an exemplary embodiment, the CG occasion(s) may first be configured in the terminal by higher layer signaling (e.g., RRC signaling, MAC CE), and at least some of the configured CG occasion(s) may be activated by the above-described DCI-based indication operation. In this case, the CG occasion index may be informed to the terminal as being explicitly included in CG configuration information or CG occasion configuration information. In addition, activation indication information of an CG occasion may include an index of the CG occasion to be activated. According to another exemplary embodiment, the CG occasion may be activated by the above-described DCI-based indication operation and simultaneously be assigned the CG occasion index. For example, indexes of CG occasions within one CG configuration may be sequentially assigned according to an order in which the CG occasions are activated. In this case, the activation indication information of the CG occasion may not include the index of the CG occasion to be activated. Instead, the activation indication information of the CG occasion may include information (e.g., CG configuration index) on the CG configuration to which the CG occasion to be activated belongs.

FIG. 17 is a conceptual diagram illustrating a first exemplary embodiment of a method of simultaneously activating a plurality of CG occasions.

Referring to FIG. 17, a first CG occasion and a second CG occasion may be activated in the terminal. The first CG occasion and the second CG occasion may be included in the same CG configuration. According to a proposed method, the plurality of CG occasions may be simultaneously activated based on a single signaling procedure. For example, information indicating activation of the first CG occasion and the second CG occasion may be transmitted to the terminal as being included in first DCI. The terminal may activate a plurality of corresponding CG occasions based on the indication information, and may transmit PUSCH in the activated CG occasions (i.e., CG PUSCH resources belonging to the CG occasions).

As in the first exemplary embodiment of FIG. 16, the same CG periodicity (or period) may be applied to a plurality of CG occasions within one CG configuration. Information on the CG periodicity may be included in CG configuration information, and the CG periodicity may be applied to all CG occasions included in the CG configuration. Alternatively, information on the CG periodicity may be included in DCI including the activation indication information. Referring to FIG. 17, first CG resource(s) and second CG resource(s) may repeatedly appear based on the same CG periodicity. A start time of the CG period (or the boundary between CG periods) may be determined based on an activation time of a reference CG occasion, a reception time of the DCI including the activation indication information, and/or a location of the CG resource(s) included in the reference CG occasion. The reference CG occasion may be one CG occasion among the plurality of CG occasions. For example, the reference CG occasion may be a CG occasion assigned a specific CG occasion index (e.g., index 0). Alternatively, the start time of the CG period may be a time after a predetermined time elapses from a reception time of the DCI including the activation indication information. The predetermined time may be predefined in the technical specification. Alternatively, the predetermined time may be determined based on configuration information transmitted from the base station to the terminal.

A time offset may be applied to arrangement of CG resource(s) corresponding to each CG occasion. In the above-described exemplary embodiment, the first CG resource(s) corresponding to the first CG occasion may be allocated to resource(s) shifted by a time offset T1 from the start time of the CG period, and the second CG resource(s) corresponding to the second CG occasion may be allocated to resource(s) shifted by a time offset T2 from the start of the CG period. Each of T1 and T2 may mean a slot offset, subslot offset, symbol offset, subframe offset, or the like, and may be expressed as the number of slots, number of subslots, number of symbols, number of subframes, or the like. In this case, a time offset for a specific CG occasion may be 0. For example, a time offset for the reference CG occasion may be 0. Alternatively, a time offset for a CG occasion having a specific CG occasion index (e.g., index 0) may be 0. In the above-described exemplary embodiment, the first CG occasion may be the reference CG occasion or a CG occasion having an index of 0, and T1 may be 0.

The first DCI may include resource allocation information and scheduling information of CG resources (i.e., first CG resource(s) and second CG resource(s)) for the first CG occasion and the second CG occasion to be activated. In this case, the information amount of the resource allocation information and the scheduling information may increase in proportion to the number of CG occasions to be simultaneously activated, and when the DCI payload size excessively increases, the terminal may need to perform an additional channel decoding operation in order to receive DCI having a separate payload size. As a result, reception complexity of the terminal may increase.

As a method for solving the above-described problem, restrictions may be applied to resource allocation and/or scheduling of a plurality of CG occasions within one CG configuration. Specifically, within one CG configuration, resource allocation and/or scheduling of the first CG occasion and resource allocation and/or scheduling of the second CG occasion may be associated. For example, scheduling parameters of the second CG occasion may have the same values as scheduling parameters of the first CG occasion, or may be determined based on the scheduling parameters of the first CG occasion. The scheduling parameters may include the number of repetitions of CG PUSCH transmission, MCS, RV, RV pattern, number of transmission layers, PUSCH mapping type, DM-RS mapping information, and/or the like. For another example, resources of the second CG occasion (e.g., CG resource(s) corresponding to the resources of the second CG occasion) may coincide partially with resources of the first CG occasion (e.g., CG resource(s) corresponding to the resources of the first CG occasion). Alternatively, the resources of the second CG occasion may be determined based on the resources of the first CG occasion.

According to an exemplary embodiment, a frequency resource of the first CG occasion and a frequency resource of the second CG occasion may be the same within one CG configuration. When frequency hopping is applied to the first CG occasion, a frequency resource of each hop or a hopping pattern to the first CG occasion may be equally applied to the second CG occasion. The common frequency domain resource allocation information may be transmitted to the terminal as being included in the above-described DCI. Alternatively, a frequency resource region of the second CG occasion may be determined based on a frequency resource region of the first CG occasion. For example, the frequency resource region of the second CG occasion may be a region obtained by shifting the frequency resource region of the first CG occasion. The frequency resource region of the first CG occasion may be indicated to the terminal through the DCI described above. In addition, a value for the shifting (i.e., shift value) may be transmitted to the terminal as being included in the above-described DCI. The shift value may be expressed as the number of RBs (e.g., the number of PRBs and the number of CRBs), the number of subcarriers, the number of RB groups, or the like.

Additionally or alternatively, a time resource component of the second CG occasion may be the same as a time resource component of the first CG occasion within one CG configuration. For example, a duration of a CG-PUSCH belonging to the second CG occasion (e.g., the number of symbols mapped to the CG-PUSCH) may coincide with a duration of a CG-PUSCH belonging to the first CG occasion (e.g., the number of symbols mapped to the CG-PUSCH). Information on the common PUSCH duration may be transmitted to the terminal as being included in the above-described DCI.

For another example, a CG-PUSCH resource set (or CG-PUSCH resource pool) composed of candidate CG-PUSCH resources may be configured within one CG configuration. CG occasions belonging to the CG configuration (e.g., CG resource(s) corresponding to the CG occasions) may be configured based on the CG-PUSCH resource set. Specifically, each CG occasion within the CG configuration may have one or more candidate CG-PUSCH resource(s) belonging to the CG-PUSCH resource set as CG resource(s). The candidate CG-PUSCH resources may mean both candidate frequency resources and candidate time resources of CG-PUSCH. Alternatively, the candidate CG-PUSCH resource may mean a candidate time resource of the CG-PUSCH.

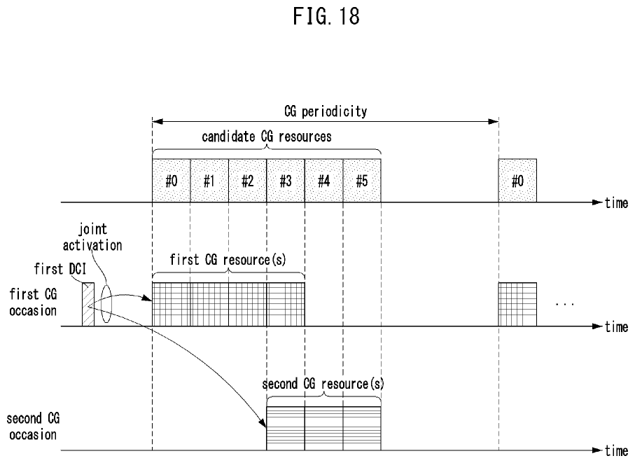

FIG. 18 is a conceptual diagram illustrating a second exemplary embodiment of a method of simultaneously activating a plurality of CG occasions.

Referring to FIG. 18, a first CG occasion and a second CG occasion may be activated in the terminal. The first CG occasion and the second CG occasion may be included in the same CG configured. Regarding the CG configuration, the terminal may receive configuration information of a CG-PUSCH resource set. That is, the CG-PUSCH resource set may be configured in the terminal. The CG-PUSCH resource set may include 6 candidate CG-PUSCH resources. According to the proposed method, CG resources of the first CG occasion and CG resources of the second CG occasion may be configured based on the CG-PUSCH resource set. The CG resources of the first CG occasion and the CG resources of the second CG occasion may include at least some of the candidate CG-PUSCH resources, respectively. The first CG occasion may include candidate CG-PUSCH resources #0 to #3, and the second CG occasion may include candidate CG-PUSCH resources #3 to #5.

According to an exemplary embodiment, the above-described operation may be performed as being limited to a time resource. For example, the candidate CG-PUSCH resources may be CG-PUSCH time resource candidates, and CG-PUSCH time resources of the first CG occasion and CG-PUSCH time resources of the second CG occasion may be allocated based on the candidate CG-PUSCH time resources. In this case, a frequency region to which the first CG occasion is allocated and a frequency region to which the second CG occasion is allocated may be the same as or different from each other.

Candidate CG-PUSCH resources constituting the CG-PUSCH resource set may be allocated to a plurality of slots, and the respective candidate CG-PUSCH resources may be allocated within one slot. In this case, the candidate CG-PUSCH resources constituting the CG-PUSCH resource set may have the same duration (e.g., the number of mapped symbols). Additionally or alternatively, the candidate CG-PUSCH resources constituting the CG-PUSCH resource set may be consecutively arranged in the time domain. Alternatively, the candidate CG-PUSCH resources constituting the CG-PUSCH resource set may be consecutively arranged temporally within each slot. That is, within the CG-PUSCH resource set, the first symbol of the (n+1)-th candidate CG-PUSCH resource and the last symbol of the n-th candidate CG-PUSCH resource may be contiguous to each other. According to the methods described above, configuration information of the CG-PUSCH resource set may be effectively compressed, and a signaling overhead may be reduced.

The configuration information of the CG-PUSCH resource set may be transmitted to the terminal based on higher layer signaling (e.g., RRC signaling, MAC CE). For example, the configuration information of the CG-PUSCH resource set may be included in configuration information of the CG configuration corresponding to the CG-PUSCH resource set. On the other hand, information indicating candidate CG-PUSCH resources included in each CG occasion may be transmitted to the terminal as being included in DCI (or another DCI or another physical layer signaling) including activation indication information of the CG occasion(s). Specifically, information indicating candidate CG-PUSCH resources included in each CG occasion may indicate candidate CG-PUSCH resource(s) (or index(s) thereof) included in each CG occasion, the first candidate CG-PUSCH resource and the number of CG-PUSCH resources included in each CG occasion, the first candidate CG-PUSCH resource and the last candidate CG-PUSCH resource included in each CG occasion, and/or the like.

The first CG occasion and the second CG occasion may be simultaneously activated based on a single signaling procedure. For example, information indicating activation of the first CG occasion and the second CG occasion may be transmitted to the terminal as being included in first DCI. Alternatively, the first CG occasion and the second CG occasion may be activated based on individual signaling procedures. For example, information indicating activation of the first CG occasion and the second CG occasion may be respectively transmitted to the terminal as being included in the first DCI and second DCI. The terminal may activate corresponding CG occasion(s) based on the indication information, and transmit PUSCH in the activated CG occasion(s) (i.e., CG PUSCH resource(s) belonging to the CG occasion(s)).

The above-described method of simultaneously activating a plurality of CG occasions (hereinafter referred to as ‘first method’) may be applied to all CG occasions belonging to the CG configuration. Alternatively, the first method may be applied to some CG occasions belonging to the CG configuration. In the latter case, the activation indication information of the CG occasion(s) may include index(es) of the CG occasion(s) to be activated. In addition, the above-described method of individually activating the CG occasion may correspond to a specific case of the first method (e.g., when the number of CG occasion(s) to be activated is 1).

On the other hand, an operation of releasing a CG occasion may be performed in a simpler method than the above-described activation operation. Similar to the activation operation, a plurality of CG occasions belonging to the same CG configuration may be released based on individual signaling procedures. Alternatively, a plurality of CG occasions belonging to the same CG configuration may be simultaneously released based on a single signaling procedure. Information indicating to release the CG occasion(s) may be transmitted to the terminal as being included in DCI. The indication information may include index(es) of CG occasion(s) to be released. The terminal may release the indicated CG occasion(s) based on the indication information. The terminal may consider CG resources appearing after a reference time (e.g., reference slot, reference symbol, reference subframe) determined based on a reception time of the DCI as invalid, and may not perform a PUSCH transmission operation in the CG resources. When it is indicted to release a plurality of CG occasions, the indicated plurality of CG occasions may be released at the same time (e.g., the same slot, the same symbol, the same subframe). The above-described release method may be applied to all CG occasions belonging to the CG configuration. Alternatively, the above-described release method may be applied to some CG occasions belonging to the CG configuration. In the latter case, the release indication information of the CG occasion(s) may include index(es) of the CG occasion(s) to be released.

The terminal may inform the base station of information on the selected CG occasion(s) (or CG-PUSCH resource(s) and CG-PUSCH transmission parameter(s) corresponding to the CG occasion(s)) through transmission of an uplink signal. Additionally or alternatively, the terminal may information the base station of information on CG occasion(s) not selected by the terminal (or CG-PUSCH resource(s) and CG-PUSCH transmission parameter(s) corresponding to the CG occasion(s)) through transmission of an uplink signal. The information may include index(es) of selected CG occasion(s) and/or index(es) of non-selected CG occasion(s) within the CG configuration. For example, the information (or at least part of the information) may be included in the uplink signal, and the uplink signal may be transmitted to the base station. In this case, the information may include information on the CG-PUSCH transmission parameters. In addition, the base station may identify the information (or at least part of the information) based on a location of a resource in which the uplink signal is received. In this case, the information may include CG-PUSCH resource information. In order to support the above-described operation, the terminal may receive configuration information of a plurality of uplink resources from the base station for transmission of the uplink indication signal, select one uplink resource among the plurality of uplink resources, and transmit the uplink indication signal in the selected uplink resource.

As described above, the CG occasion selected by the terminal may mean a CG occasion including a CG resource through which a PUSCH is transmitted by the terminal. On the other hand, the CG occasion not selected by the terminal may mean a CG occasion that does not include a CG resource through which a PUSCH is transmitted by the terminal. The operation for the terminal to select CG occasion(s) within the CG configuration may be performed for each CG period. The terminal may select the first CG occasion and the second CG occasion in the first CG period and the second CG period, respectively, and transmit PUSCHs in the selected CG occasion. In addition, the terminal may select a plurality of CG occasions within one CG period, and may transmit PUSCHs in the selected plurality of CG occasions.

The information on the selected CG occasion(s) and/or information on the non-selected CG occasion(s) may be defined as UCI (e.g., CG-UCI). Alternatively, the information on the selected CG occasion(s) and/or information on non-selected CG occasion(s) may be included in UCI. The terminal may transmit the UCI together with a CG-PUSCH to the base station using a part of a CG-PUSCH resource. Alternatively, the terminal may transmit the UCI to the base station using a part of the CG-PUSCH resource, and may not transmit a CG-PUSCH in the CG-PUSCH resource. Alternatively, the terminal may receive configuration information of a resource (e.g., PUCCH resource) separate from the CG-PUSCH resource from the base station for transmission of the UCI, and may transmit an uplink signal (e.g., PUCCH) including the UCI to the base station in the configured resource (e.g., PUCCH resource). Alternatively, the terminal may multiplex the UCI with an uplink signal (e.g., PUSCH) and transmit the multiplexed UCI and uplink signal (e.g., PUSCH) to the base station.

The terminal may receive configuration information of a plurality of resources for transmission of the UCI. For example, the plurality of resources may be CG-PUSCH resources configured by different CG occasions. The terminal may form a first CG-PUSCH resource based on the first CG occasion and may form a second CG-PUSCH resource based on the second CG occasion. In a procedure for transmitting a CG-PUSCH in the first CG-PUSCH resource, the terminal may transmit both UCI and the CG-PUSCH in the first CG-PUSCH resource. The UCI may include scheduling information or transmission parameters of the CG-PUSCH. In addition, the UCI may include information on whether the first CG occasion is selected. Alternatively, the UCI may include information on whether the first CG occasion and the second CG occasion are selected (e.g., a set of selected CG occasions and/or a set of non-selected CG occasions). In a procedure of receiving UCI in the first CG-PUSCH resource, the base station may expect to receive UCI and a CG-PUSCH in the first CG-PUSCH resource. In addition, the base station may identify information necessary for CG-PUSCH reception in the first CG-PUSCH resource based on the received UCI. In a procedure for transmitting a CG-PUSCH in the second CG-PUSCH resource, the terminal may transmit both UCI and the CG-PUSCH in the second CG-PUSCH resource. The UCI may include scheduling information or transmission parameters of the CG-PUSCH. In addition, the UCI may include information on whether the second CG occasion is selected (or used). Alternatively, the UCI may be information on whether the first CG occasion and the second CG occasion are selected (or used) (e.g., a set of selected CG occasions and/or a set of non-selected CG occasions). In a procedure of receiving UCI in the second CG-PUSCH resource, the base station may expect to receive UCI and a CG-PUSCH in the second CG-PUSCH resource. According to the above-described method, information on a resource of the CG-PUSCH may be identified by the base station based on a location of a resource where the UCI is transmitted.

The base station may perform an UCI reception operation independently of a CG-PUSCH reception operation. To support this operation, the terminal may perform an independent channel coding procedure for each of the UCI and the CG-PUSCH transmitted in the same CG-PUSCH resource. The base station may receive a DM-RS in the CG-PUSCH resource through which the UCI is transmitted, and may receive the UCI based on the DM-RS. The UCI may be mapped to symbol(s) following symbol(s) to which the DM-RS is mapped in the CG-PUSCH resource.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, configured grant (CG) configuration information including a plurality of CG occasions;
receiving, from the base station, first downlink control information (DCI);
activating a first CG occasion and a second CG occasion among the plurality of CG occasions based on indication information included in the first DCI;
selecting at least one CG occasion(s) from among the activated first CG occasion and second CG occasion; and
transmitting a physical uplink shared channel (PUSCH) to the base station based on the selected CG occasion(s),
wherein the first CG occasion includes N1 PUSCH resource(s), the second CG occasion includes N2 PUSCH resource(s), and N1 and N2 are natural numbers.

2. The method according to claim 1, wherein the first DCI further includes resource allocation information of the N1 PUSCH resource(s) and the N2 PUSCH resource(s).

3. The method according to claim 1, wherein the CG configuration information includes information on a PUSCH resource set including candidate PUSCH resource(s), and the N1 PUSCH resource(s) and the N2 PUSCH resource(s) are determined based on the PUSCH resource set.

4. The method according to claim 1, wherein the N1 PUSCH resource(s) and the N2 PUSCH resource(s) repeatedly appear according to a common periodicity.

5. The method according to claim 1, wherein a duration of the N1 PUSCH resource(s) and a duration of the N2 PUSCH resource(s) are same.

6. The method according to claim 1, wherein a time when the first CG occasion is activated and a time when the second CG occasion is activated are same.

7. The method according to claim 1, wherein information on the selected CG occasion(s) is included in uplink control information (UCI), and the UCI is transmitted by the terminal to the base station.

8. The method according to claim 1, wherein information on one or more CG occasion(s) other than the selected CG occasion(s) among the plurality of CG occasions is included in UCI, and the UCI is transmitted by the terminal to the base station.

9. The method according to claim 8, wherein the PUSCH is not transmitted in PUSCH resource(s) included in the one or more CG occasion(s).

10. The method according to claim 1, further comprising:
receiving, from the base station, second DCI including release indication information; and
releasing at least the N1 PUSCH resource(s) based on the release indication information,
wherein the release indication information includes an index of the first CG occasion.

11. A method of a base station, comprising:
transmitting, to a terminal, configured grant (CG) configuration information including a plurality of CG occasions;
transmitting first downlink control information (DCI) to the terminal; and
receiving, from the terminal, a physical uplink shared channel (PUSCH) in at least one CG occasion(s) of a first CG occasion and a second CG occasion activated based on indication information included in the first DCI among the plurality of CG occasions,
wherein the first CG occasion includes N1 PUSCH resource(s), the second CG occasion includes N2 PUSCH resource(s), and N1 and N2 are natural numbers.

12. The method according to claim 11, wherein the first DCI further includes resource allocation information of the N1 PUSCH resource(s) and the N2 PUSCH resource(s).

13. The method according to claim 11, wherein the CG configuration information includes information on a PUSCH resource set including candidate PUSCH resource(s), and the N1 PUSCH resource(s) and the N2 PUSCH resource(s) are determined based on the PUSCH resource set.

14. The method according to claim 11, wherein the N1 PUSCH resource(s) and the N2 PUSCH resource(s) repeatedly appear according to a common periodicity.

15. The method according to claim 11, wherein a duration of the N1 PUSCH resource(s) and a duration of the N2 PUSCH resource(s) are same.

16. The method according to claim 11, wherein a time when the first CG occasion is activated and a time when the second CG occasion is activated are same.

17. The method according to claim 11, further comprising: receiving, from the terminal, uplink control information (UCI) including information on the at least one CG occasion(s) in which the PUSCH is received.

18. The method according to claim 11, further comprising: receiving, from the terminal, UCI including information on one or more CG occasion(s) excluding the at least one CG occasion(s) in which the PUSCH is received among the plurality of CG occasions.

19. The method according to claim 18, wherein the PUSCH is not transmitted in PUSCH resource(s) included in the one or more CG occasion(s).

20. The method according to claim 11, further comprising: transmitting, to the base station, second DCI including release indication information, wherein at least the N1 PUSCH resource(s) is released based on the release indication information, and the release indication information includes an index of the first CG occasion.
